(19) United States
(12) Patent Application Publication
(10) Pub. No.: US 2018/0130285 A1
(43) Pub. Date: May 10, 2018

(54) GAMING DEVICE HAVING A NUMERIC DISPLAY AWARD

(71) Applicant: High 5 games, LLC, New York, NY (US)

(72) Inventors: Raymond Ang, New York, NY (US); Anthony Singer, New York, NY (US); Daniel Marks, New York, NY (US); Howard Marks, New York, NY (US)

(73) Assignee: High 5 games, LLC, New York, NY (US)

(21) Appl. No.: 15/625,329

(22) Filed: Jun. 16, 2017

Related U.S. Application Data
(63) Continuation-in-part of application No. 15/012,836, filed on Feb. 1, 2016.
Application No. 15/012,836 is a continuation-in-part of application No. 15/287,425, filed on Oct. 6, 2016.
Application No. 15/287,425 is a continuation-in-part of application No. 15/234,784, filed on Aug. 11, 2016.
Application No. 15/234,784 is a continuation-in-part of application No. 15/285,652, filed on Oct. 5, 2016.

(51) Int. Cl. G07F 17/32; G07F 17/34

(52) U.S. Cl. CPC G07F 17/3213; G07F 17/3244; G07F 17/34

(57) ABSTRACT

A game is provided that may include a plurality of reels, each of the reels including a plurality of symbol positions; at least one reel of the plurality of reels including a number of denomination symbols; at least one reel of the plurality of reels including a number of numerical values; a set of program instructions executable to implement: accepting a wager associated with a number of pay lines; determining a game outcome including a stopping point of the plurality of reels; displaying a portion of the plurality of reels at the stopping point on a display device; and issuing an award indicated by numerical values on the same pay line as a denomination symbol.

### CROSS-REFERENCE TO RELATED APPLICATIONS

This application is a continuation-in-part of U.S. patent application Ser. No. 15/012,836, filed Feb. 1, 2016, entitled “Game machine having a plurality of ways for a user to obtain payouts based on the appearance of any and all symbols within an active symbol matrix (WYSIWYG),” and is a continuation in part of U.S. patent application Ser. No. 15/287,425, filed Oct. 6, 2016, entitled “Game Machine Having a Plurality of Ways for a User to Obtain Payouts Based on the Appearance of Any and All Symbol Matrix,” and is a continuation in part of U.S. patent application Ser. No. 15/234,784, filed Aug. 11, 2016, entitled “Game Machine Having a Plurality of Ways for a User to Obtain Payouts Based on the Appearance of Any and All Symbol Matrix,” and is a continuation in part of U.S. patent application Ser. No. 15/285,652, filed Oct. 5, 2016, entitled “Game Machine Having a Plurality of Ways for a User to Obtain Payouts Based on the Appearance of Any and All Symbol Matrix,” the disclosures of which are incorporated by reference herein in their entireties.

### BACKGROUND

### Field of the Invention

Embodiments of the present disclosure generally relate to a gaming device having a numeric display award. More specifically, embodiments of the present invention generally relate to a slot game whereby an award is based on a numeric value displayed across reels, or the like.

### Description of Related Art

Slot games are immensely popular throughout the world. Slot games may generally be played on dedicated slot machines or many other electronic devices. For example, some slot games may be played on personal computers, tablet computers, mobile phones, smart televisions, and/or the like. Although many devices are capable of executing slot games today, the term “slot” is derived originally from a coin accepting slot present in the earliest slot machines. Advances in technology have allowed newer slot machines and other electronic devices to accept other forms of payment and/or credits.

To play a conventional slot machine, a player deposits money in the form of coins, gaming tokens or paper currency either into a coin head or bill acceptor. The coins and gaming tokens are collected in a reservoir inside the gaming machine while the paper currency is collected in the bill acceptor inside the gaming machine. A currency detector, or the like, validates the coins, gaming tokens, paper currency, or other form of credits as authentic or not counterfeit. Currency detectors are generally known in gaming machines and slot machines. Currency detectors may include coin detectors, optical sensors, giant magnetoresistance (GMR) sensor proximity detectors, weight detectors, size detectors, thickness detectors, composition detectors, banknote validators/acceptors, token validators/acceptors, voucher validators/acceptors, magnetic stripe card validators/acceptors, barcode readers, and/or the like. A player may also deposit currency into certain slot machines by inserting, swiping, or scanning a payout ticket, a voucher, a member card, a credit card, a debit card, or the like into a validator. As used herein, the term “currency” may include real money, points, and/or credits.

Once the currency detector or validator authenticates the currency, a visual display may show the appropriate number of playing credits on a credit or playing meter. As used herein, the terms “visual display” or “display” may comprise an output device for presentation of information in accordance with the present disclosure. A display or visual display may work together with a processor and memory to display reels, symbols, credit counters, slot games, bonus games, videos, graphics, logos, all slot game features, components, and parts disclosed herein, and/or the like. For example, a display may be an electronic display, a digital display, a cathode ray tube display (CRT), a Light-emitting diode display (LED), an electroluminescent display (ELD), an electronic paper display, an E Ink display, a Plasma display panel (PDP), a Liquid crystal display (LCD), a High-Performance Addressing display (HPA), a thin-film transistor display (TFT), an Organic light-emitting diode display (OLED), a Surface-conduction electron-emitter display (SED), a field emission display (FED), a laser TV, a carbon nanotubes display, a quantum dot display, an interferometric modulator display (IMOD), a digital microshutter display (DMS), a swept-volume display, a varifocal mirror display, an emissive volume display, a laser display, a holographic display, a light field display, a volumetric display, and/or the like. The playing credits may be shown via a credit meter, or the like, on a portion the display as a monetary amount, a number of spins, or some other multiplier of the monetary value or currency deposited. For example, a twenty-five cent gaming machine may accrue one credit for every twenty-five cents deposited or four credits for each dollar that is deposited into the gaming machine.

After accruing credits on the credit meter, the player determines how many credits he wishes to wager or risk (the “stake”) on the next play of the game, which may include a spin of the slot reels. As used herein, a “reel” may include an arrangement of symbols. Traditional mechanical and electromechanical slot machines have a set of adjacent reels having symbols, numbers, pictures, or the like disposed in different positions on physical reels. Traditionally, mechanical or electromechanical slot machines include a number of rotating physical reels each having an outer circumferential reel strip printed with a number of play symbols usually consisting of items such as pictures of fruit, playing cards, other symbols, or the like. The reels are located in a side by side relationship for independent movement about a common axis. In the some electromechanical machines each of the reels are driven individually by a stepper motor that serves to rotate the reels about the common axis. In order to house the reels, conventional slot machines require a housing having a depth sufficient to accommodate the reels. These reels can be mounted on modules or reel mounting mechanisms which can each be separately inserted into the housing.

As slot game technology advanced, digital reel strips, or digital arrangements of symbols, became possible. Digital reel strips may be stored in memory and may include an arrangement of symbols. A visual representation of the reel strips may be displayed on a digital display, or the like, to simulate the visual effect of reels spinning as they would in a conventional mechanical or electromechanical slot game. The arrangement of symbols may include the possible game outcomes for a particular reel. Each reel may include one or more symbol positions where one or more symbols may be located. An outcome generally includes the stopping point of one or more reels, which may be displayed to the player. A number of symbols on a reel may be displayed in accordance with its stopping point determined by a processor. In traditional mechanical or electromechanical slot gaming machines, a window or aperture would be present allowing the player to see a portion of the reels. The player would see the reels physically spin during gameplay and eventually terminate at a stopping point, wherein a certain number of symbols would be displayed in the window.

There are many advantages to using digital reels over physical reels. While physical reels are limited to the number of symbols that can physically fit on the reels, digital reel strips can include any suitable number of symbols, often in the hundreds or thousands. In some electronic slot games, reels are arranged in reel strips having a length set by an administrator, or the like. To play the game, after setting a wager, the player initiates the game for example, by spinning the reels mechanically or digitally. The game may be initiated by an input device by a player by pressing a spin button or touch screen option, by pulling a handle, and/or the like.

In mechanical or electromechanical slot machines, such player action, in turn, triggers the start of the reel motors which rotate the reels. In digital slot games, the spinning of the reels may be simulated. The reels may then stopped at random positions, usually under control of a microprocessor, or the like. The machine determines if a reward should be issued to the player in accordance with a pay table that may be configured by an administrator. For example, given combinations of the play symbols displayed along a pay line may result in an award to the player. In traditional slot games, each spin of the reels is typically a separate and distinct game, which has no relationship with any prior or future game played on that machine. In some games with digital reels, a game, outcome including a stop position for each of the reels, is determined by the microprocessor and a video or digital simulation of reels spinning and coming to a stopping point may be shown on a display. When the reels stop spinning, or the like, symbols are displayed on the display and the results of the game are presented to the user. The player then collects credits for winning combinations, if any, according to a pay table.

Slot game symbols may be located on one or more reels. Reels may be physical reels, digital reel strips, and/or the like. Digital reel strips may include an arrangement of symbols stored digitally, or the like. Symbols disposed on a physical reel physically spin when the reel spins. Some electronic slot machines include a processor working with a display to depict a simulation of a reel spinning, or the like. A slot game may include a processor, memory, and a display working together to display a digital representation of a physical reel after a player activates a game.

As used herein, the term “symbol” may refer to an indicia or indicator. At the conclusion of a game or spin, certain combinations of symbols may result in a reward for the player. In physical reels, symbols are displayed on the reel at various points around the outer circumference of the slot reel. Digital reels include various symbol positions, or positions on the reel strips where symbols are positioned. Reels may be placed or displayed adjacent to each other, and are often arranged in columns. In most embodiments, there are at least three reels in the reel sets and most often at least five.

The visual display includes a visible display area whereby a player can see a portion of the reels. The visual display area (also called a “symbol matrix”) displays a portion of each of the plurality of the reels. A typical example is a symbol matrix that displays a portion of three to five reels. In this typical example, the resulting symbol matrix is a rectangular display of symbols (nine symbols when three columns and three rows are visible and fifteen symbols when five columns and three rows are visible).

Within the symbol matrix, positions on the slot reels may be referred to according to column, from left to right, and row from top to bottom. For example, symbol matrix position 1/2 is located in column 1 (left-most column) and row 2 (second row from the top). In some embodiments, the visible display area may be a non-rectangular shape. For example, the visible display may display one row of the first reel, two rows of the second reel, and one row of the third reel. In this example, four symbol positions would be visible. In some embodiments, only one position on each reel is visible to a player (“independent reels”). In some of these embodiments, multiple reels are vertically aligned and appear to be one column to the player.

In some embodiments, there are hidden reels whereby none of the reel slots are visible. In some if these embodiments, the hidden reels become visible after a triggering event. The player collects credits for winning combinations based on the symbols displayed in the visible symbol matrix. In some embodiments, a player may collect additional credits for winning combinations based on symbols in non-visible positions on the reels or on symbols that are on hidden reels.

Winning Combinations.

Players collect credits for predetermined winning symbol combinations that appear in specific positions (pay lines) on the slot reels. Winning combinations typically require that three or more of the same symbols appear adjacent to each other starting from the leftmost position of a pay line (“line pays”). For example, a player may collect a line pay if three banana symbols appeared in symbol positions 1/1, 2/1, and 3/1 on a pay line that includes symbol positions 1/1, 2/1, 3/1, 4/1, and 5/1.

A player may wager on the occurrence of a winning combination on a single pay line or on the occurrence of a winning combination on multiple pay lines. Winning combinations may also occur when three or more of the same symbols appear adjacent to each other starting from the rightmost position of a pay line. Game rules may specify that some symbols may form winning combinations if there are two or more of the same symbol (“majors”) while other symbols may only form winning combinations if there are three or more of the same symbol.

Winning combinations may occur if three or more symbols appear on a pay line regardless of whether they are adjacent or regardless of whether the first occurrence of that symbol is in the leftmost or rightmost column. In some instances, there are wild symbols or substitute symbols that can be matched with other symbols. Players may also collect credits for predetermined winning combinations that appear anywhere on a pay line (“line scatter pays”) or anywhere on the slot reels (“reel scatter pays”). For example, a player may collect a line scatter pay if three banana symbols appeared in symbol positions 1/1, 3/1, and 5/1 on a pay line using symbol positions 1/1, 2/1, 3/1, 4/1, and 5/1; and collect a reel scatter pay if three banana symbols appear anywhere on the visible slot reels.

Pay Table.

Credits are awarded to the player for each winning symbol combination based on a predetermined schedule. For line pays and line scatter pays, the number of credits wagered on the winning pay line multiplies the number of credits indicated by the pay table. For example, a player may wager two credits each on five pay lines, spin the reels, and collect twice the amount indicated on the pay table for a line pay or line scatter pay appearing on any of the five played pay lines. For reel scatter pays, the total number of credits wagered multiplies the number of credits indicated by the pay table. For example, a player may wager ten total credits, spin the reels, and collect ten times the amount indicated on the pay table for a reel scatter pay appearing on anywhere on the slot reels.

Following any type of pay (e.g., line pays, line scatter pays, or reel scatter pays), credits won are added to the player's credit balance shown on the credit meter. As long as the player has credits on the credit meter, the player may continue to play the game. Following any spin, the player may collect the credit balance by pressing a Cash Out button. Credits may be paid out in many different ways. Credits can be paid out as cash or cash alternatives or as credits to play the game.

Conventional slot machines are limited in that they only issue awards for the types of combinations of symbols as described above. That is, awards are paid only in accordance with a fixed pay table. As a result of this limitation, players must learn how and why certain combinations of symbols form winning combinations; players must memorize the awards listed on the pay table for each of the winning symbol combinations; players suffer from the disappointment of “near-misses” of winning combinations which line-up just off the pay lines; and players suffer from boredom of playing “new” games that really use the same, old “pay line-pay table” concept.

In other slot machines, players are awarded for the numerical value of symbols appearing on a display device without regard to their alignment. This concept, known as What You See Is What You Get (“WYSIWYG”). In these embodiments, players are issued awards based on each numeric symbol appearing in certain symbol positions that are displayed without regard to the alignment of the symbols as further disclosed in United States Patent Publication 2011-0165934 which is incorporated by reference in its entirety as if fully set forth herein.

While the above elements are common to many slot machine games, without more, players are often easily bored by simple conventional game play. A need exists for a gaming apparatus having an improved game play. Embodiments of the present invention may include a machine that provides cross-column numeric wins. Embodiments of the present invention may provide new and exciting game play while simultaneously simplifying visible wins.

### SUMMARY

Embodiments of the present disclosure generally relate to a gaming device having cross-column numeric awards. More specifically, embodiments of the present invention may include a machine that has an activator symbol with an associated denomination and awards the following multi-digit numeric value that appears across multiple columns.

In some embodiments, a game comprises: a plurality of reels, each of the reels comprising a plurality of symbol positions; at least one reel of the plurality of reels comprising a number of denomination symbols; at least one reel of the plurality of reels comprising a number of numerical values; a set of program instructions executable to implement: accepting a wager associated with a number of pay lines; determining a game outcome including a stopping point of the plurality of reels; displaying a portion of the plurality of reels at the stopping point on a display device; and issuing an award indicated by numerical values on the same pay line as a denomination symbol.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1A depicts a front perspective view of a gaming device in the form of a slot machine in accordance with one embodiment of the present invention;

FIG. 1B depicts a front perspective view of a gaming device in the form of a slot machine in accordance with embodiments of the present invention;

FIG. 1C depicts a front perspective view of a gaming device in the form of a mobile device in accordance with one embodiment of the present invention;

FIG. 1D depicts a front perspective view of a gaming device in the form of a personal computer in accordance with one embodiment of the present invention;

FIG. 2A depicts a schematic block diagram of a computer system, which may be used with any of the gaming devices of FIGS. 1A-1D, in accordance with embodiments of the present invention;

FIG. 2B depicts a schematic block diagram illustrating a plurality of gaming terminals and communication with a central controller in accordance with one embodiment of the present invention;

FIG. 3A depicts a view of a plurality of reels in accordance with embodiments of the present invention;

FIG. 3B depicts a view of an intersection of the reels shown in FIG. 3A with a display device;

FIG. 4 depicts a view of a display device in accordance with embodiments of the present invention;

FIG. 5 depicts a view of a display device in accordance with embodiments of the present invention where some of the denominations are blank;

FIG. 6A depicts a view of a display device in accordance with embodiments of the present invention where some of the denominations are “credits;”

FIG. 6B depicts a view of a display device in accordance with embodiments of the present invention where some of the denominations are “credits;”

FIG. 7A depicts a view of a display device in accordance with embodiments of the present invention where some of the denominations are “free spins;”

FIG. 7B depicts a view of a display device in accordance with embodiments of the present invention where some of the denominations are “free spins;”

FIG. 8 depicts a view of a display device in accordance with embodiments of the present invention where there are denomination symbols on the reels;

FIG. 9A depicts a view of a display device in accordance with embodiments of the present invention where only one symbol from each of the reels is displayed;

FIG. 9B depicts a view of a display device in accordance with embodiments of the present invention where only one symbol from each of the reels is displayed;

FIG. 10 depicts a view of a display device in accordance with embodiments of the present invention where the denomination symbols are of various currencies;

FIG. 11 depicts a view of a display device in accordance with embodiments of the present invention where the numeric symbols are more than one digit;

FIG. 12A depicts a view of a display device in accordance with embodiments of the present invention where symbols involved in an award are removed and replaced with other symbols;

FIG. 12B depicts a view of a display device in accordance with embodiments of the present invention where symbols involved in an award are removed and replaced with other symbols;

FIG. 12C depicts a view of a display device in accordance with embodiments of the present invention where symbols involved in an award are removed and replaced with other symbols;

FIG. 13A depicts a view of a display device in accordance with embodiments of the present invention where symbols involved in an award are removed and replaced with other symbols, but leading zeros, which do not contribute to the amount of an award, are not removed;

FIG. 13B depicts a view of a display device in accordance with embodiments of the present invention where symbols involved in an award are removed and replaced with other symbols, but leading zeros, which do not contribute to the amount of an award, are not removed;

FIG. 13C depicts a view of a display device in accordance with embodiments of the present invention where symbols involved in an award are removed and replaced with other symbols, but leading zeros, which do not contribute to the amount of an award, are not removed;

FIG. 14A depicts a view of a display device in accordance with embodiments of the present invention where symbols involved in award are removed and replaced with other symbols;

FIG. 14B depicts a view of a display device in accordance with embodiments of the present invention where symbols involved in award are removed and replaced with other symbols;

FIG. 14C depicts a view of a display device in accordance with embodiments of the present invention where symbols involved in award are removed and replaced with other symbols;

FIG. 14D depicts a view of a display device in accordance with embodiments of the present invention where symbols involved in award are removed and replaced with other symbols;

FIG. 15A depicts a view of a display device in accordance with embodiments of the present invention where the feature is embedded in a traditional slot machine;

FIG. 15B depicts a view of a display device in accordance with embodiments of the present invention where the feature is embedded in a traditional slot machine;

FIG. 16A depicts a view of a display device in accordance with embodiments of the present invention where the feature is triggered through adjacent symbols spelling out a word; and

FIG. 16B depicts a view of a display device in accordance with embodiments of the present invention where the feature is triggered through adjacent symbols spelling out a word.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

In the following detailed description, numerous specific details are set forth in order to provide a thorough understanding of exemplary embodiments or other examples described herein. However, it will be understood that these examples may be practiced without the specific details. In other instances, well-known methods, procedures, and components have not been described in detail, so as to not obscure the following description. Furthermore, the examples disclosed herein are for exemplary purposes only and other examples may be employed in lieu of, or in combination with, the examples disclosed.

Embodiments of the present disclosure generally relate to a gaming device having coordinating secondary symbols. More specifically, embodiments of the present invention generally relate to a slot machine having secondary symbols that coordinate with each other to trigger a reward for a player. It should be appreciated that the games disclosed herein may be configured and played with real money, credits, points, and/or the like. It is also contemplated that real money may be deposited and converted into credits, points, digital currency and/or the like.

While the term “spin” is used throughout the present disclosure, it is contemplated that alternative methods of displaying game results are contemplated. For example, the game results may be displayed by simulating each symbol “dropping” into position from a top portion of the display or simply appearing without spinning. When used herein, the term “spin” is intended to cover the methods of populating a display of game results consistent with the present disclosure.

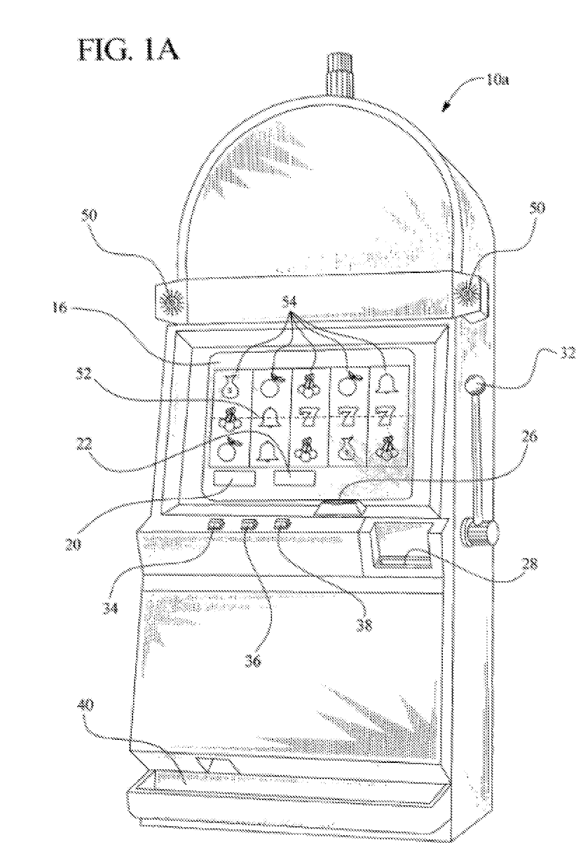

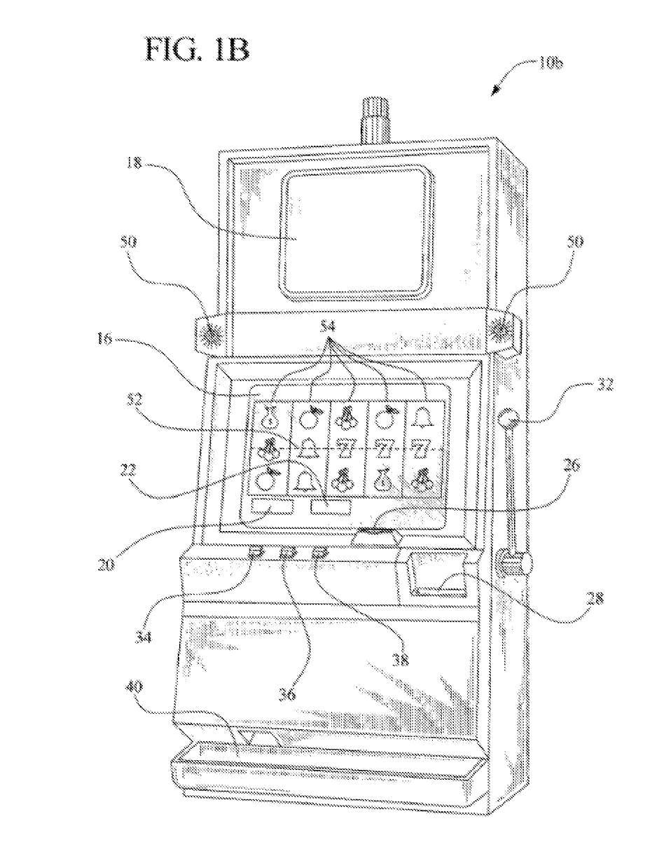

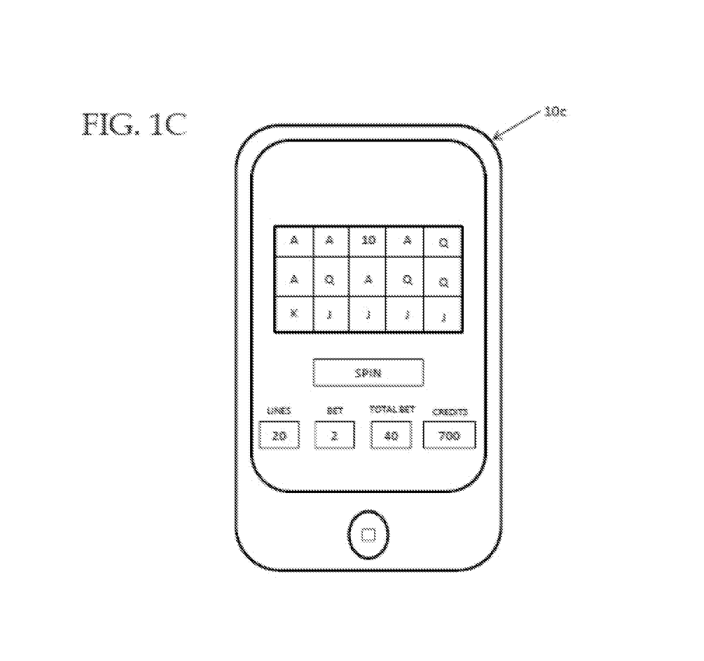

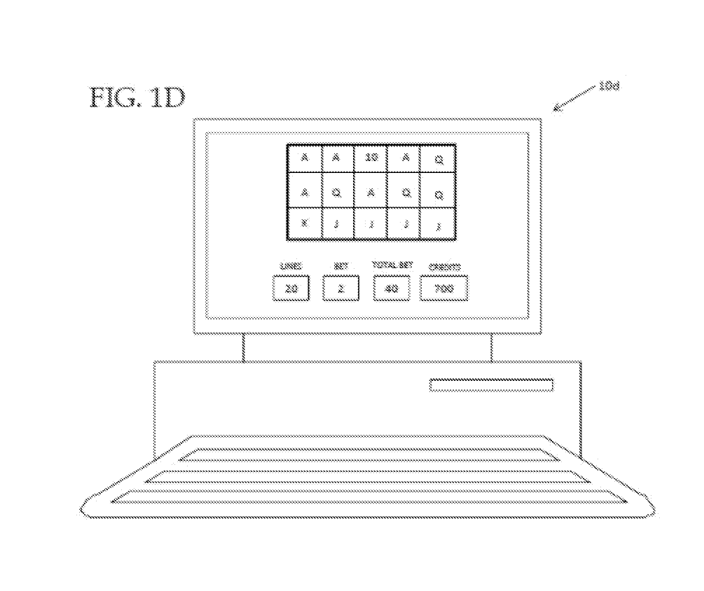

Several embodiments of the gaming device of the present invention are illustrated in FIGS. 1A and 1B as gaming device 10a and gaming device 10b, respectively. Gaming device 10a and/or gaming device 10b are generally referred to herein as gaming device 10.

In some embodiments, as illustrated in FIGS. 1A and 1B, gaming device 10 has a support structure, housing or cabinet which provides support for a plurality of displays, inputs, controls and other features of a conventional gaming machine. It is configured to allow a player to operate a game while standing or sitting. The gaming device may be positioned on a base or stand or can be configured as a pub-style table-top game (not shown) which a player can operate preferably while sitting. As illustrated by the different configurations shown in the Figures, the gaming device can be constructed with varying cabinet and display configurations suitable for playing a game in accordance with embodiments of the present disclosure.

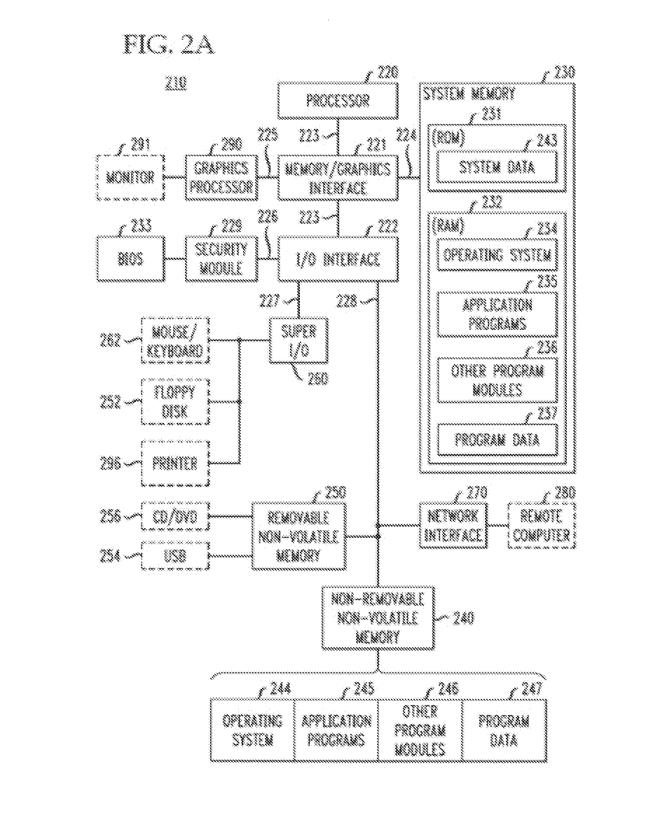

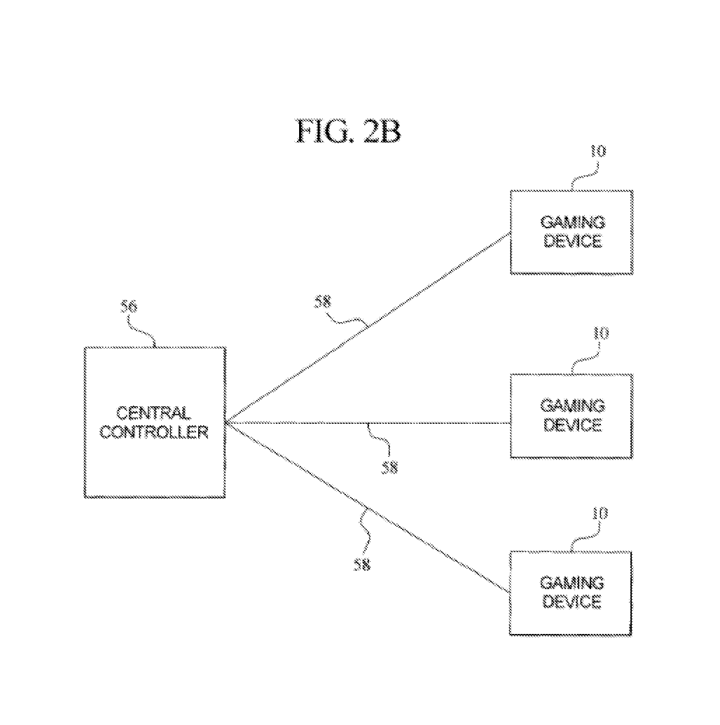

In several embodiments, the electronic gaming devices, for example, as shown in FIGS. 1A-1D, may comprise all or part of a computer system, for example, the computer system of FIG. 2. It should be appreciated, however, the computer system of FIG. 2 is merely an exemplary embodiment of an electronic device, and actual electronic devices may comprise any one or more components shown in FIG. 2A, suitable for embodiments of the present invention.

With reference to FIG. 2A, a computer system in the form of a computer 210 is shown. Components shown in dashed outline are not part of the computer 210, but are used to illustrate the exemplary embodiment of FIG. 2A. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

In the figures, a single block may be described as performing a function or functions; however, in actual practice, the function or functions performed by that block may be performed in a single component or across multiple components, and/or may be performed using hardware, using software, or using a combination of hardware and software. Skilled artisans may implement the described functionality in varying ways for each particular application, but such implementation decisions should not be interpreted as causing a departure from the scope of the present invention. Also, the example games and devices may include well-known components such as a processor, memory and the like.

The techniques described herein may be implemented in hardware, software, firmware, or any combination thereof. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry.

The term “processor,” as used herein may refer to any of the foregoing structure or any structure suitable for implementation of the techniques described herein. In some aspects, the functionality described herein may be provided within dedicated software modules or hardware modules configured as described herein. The techniques described herein may be fully implemented in one or more circuits or logic elements. In some embodiments, a processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hyper transport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and can accessed by the computer 210.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identifying and manufacturing information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other buses 226, 227 and 228 that couple a variety of internal and external devices to the computer 210. A serial peripheral interface (SPI) bus 226 may connect to a BIOS memory 233 containing the basic routines that help to transfer information between elements within computer 210, such as during start-up.

In some embodiments, a security module 229 may be incorporated to manage receipt of money/credits, issuance of money/credits, and enforcement of policies, as may be required in the gaming industry. In many embodiments, such security module 229 may be coupled with a payment acceptor built into a physical machine. A payment acceptor may include a coin slot and a payment, note or bill acceptor, where the player inserts money, coins or tokens. For example, the player can place coins in the coin slot or paper money, ticket or voucher into the payment, note or bill acceptor. In other embodiments, devices such as readers or validators for credit cards, debit cards or credit slips could be used for accepting payment. In some embodiments, a player may insert an identification card into a card reader of the gaming device. In some embodiments, the identification card is a smart card having a programmed microchip or a magnetic strip coded with a player's identification, credit totals and other relevant information. In some embodiments, money may be transferred to a gaming device through electronic funds transfer. When a player funds the gaming device, the processor determines the amount of funds entered and the corresponding amount is shown on the credit or other suitable display as described above.

A super input/output chip 260 may be used to connect to a number of ‘legacy’ peripherals, such as floppy disk 252, keyboard/mouse/buttons 262, and printer 296, as examples. The super I/O chip 260 may be connected to the I/O interface 222 with a low pin count (LPC) bus, in some embodiments. The super I/O chip 260 is widely available in the commercial marketplace.

In some embodiments, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2A illustrates a hard disk drive 240 that reads from or writes to non-removable, nonvolatile magnetic media. Removable media, such as a universal serial bus (USB) memory 252 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media, discussed above and illustrated in FIG. 2A, provide storage of computer readable instructions, data structures, program modules and other data for the computer 210. In FIG. 2A, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum; they are different elements within the computer 210. A user may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), an Ethernet-based network, a wide area network (WAN), or both, but may also include other networks. Such networking environments are commonplace in offices, enterprise-wide computer networks, intranets, and the Internet.

Returning to FIGS. 1A-1D, in some embodiments, as discussed in more detail below, the gaming device randomly generates awards and/or other game outcomes based on probability data. That is, each award or other game outcome is associated with a probability and the gaming device generates the award or other game outcome to be provided to the player based on the associated probabilities. In this embodiment, since the gaming device generates outcomes randomly or based upon a probability calculation, there is no certainty that the gaming device will ever provide the player with any specific award or other game outcome.

In some embodiments, as discussed in more detail below, the gaming device employs a predetermined or finite set or pool of awards or other game outcomes. In this embodiment, as each award or other game outcome is provided to the player, the gaming device removes the provided award or other game outcome from the predetermined set or pool. Once removed from the set or pool, the specific provided award or other game outcome cannot be provided to the player again. This type of gaming device provides players with all of the available awards or other game outcomes over the course of the play cycle and guarantees the amount of actual wins and losses.

As shown by FIGS. 1A and 1B, and supported by the elements depicted in FIG. 2A, many embodiments of the present invention comprise at least one, and often a plurality, of input devices in communication with the processor. The input devices can include any suitable device which enables the player to produce an input signal which is read by the processor, for instructing the game and/or gaming device to do something. In some embodiments, after appropriate funding of the gaming device, the input device is a game activation device, such as a pull arm 32 or a play button 34 which is used by the player to start any primary game or sequence of events in the gaming device. The play button can be any suitable play activator such as a bet one button, a max bet button or a repeat the bet button. In some embodiments, upon appropriate funding, the gaming device begins the game play automatically. In some embodiments, upon the player engaging one of the play buttons, the gaming device automatically activates game play.

In some embodiments, as shown in FIGS. 1A and 1B, an input device may be a bet one button 36. The player places a bet by pushing the bet one button. The player can increase the bet by one credit each time the player pushes the bet one button. When the player pushes the bet one button, the number of credits shown in the credit display preferably decreases by one, and the number of credits shown in the bet display preferably increases by one. In some embodiments, one input device is a bet max button (not shown) which enables the player to bet the maximum wager permitted for a game of the gaming device.

In some embodiments, an input device may be a cash-out button 38. The player may push the cash out button and cash out to receive a cash payment or other suitable form of payment corresponding to the number of remaining credits. In some embodiments, when the player cashes out, the player receives the coins or tokens in a coin payout tray 40. In some embodiments, when the player cashes out, the player may receive other payout mechanisms such as tickets or credit slips redeemable by a cashier or funding to the player's electronically recordable identification card.

In some embodiments, an input device may be a touch-screen coupled with a touch-screen controller, or some other touch-sensitive display overlay to allow for player interaction with the images on the display. The touch-screen and the touch-screen controller are connected to a video controller. A player can make decisions and input signals into the gaming device by touching touch-screen at the appropriate places.

In some embodiments, the gaming device may include a sound generating device controlled by one or more sound cards which function in conjunction with the processor. In some embodiments, the sound generating device includes at least one and preferably a plurality of speakers or other sound generating hardware and/or software for generating sounds, such as playing music for the primary and/or secondary game or for other modes of the gaming device, such as an attract mode. In some embodiments, the gaming device provides dynamic sounds coupled with attractive multimedia images displayed on one or more of the display devices to provide an audio-visual representation or to otherwise display full-motion video with sound to attract players to the gaming device. During idle periods, the gaming device may display a sequence of audio and/or visual attraction messages to attract potential players to the gaming device. The videos may also be customized for or to provide any appropriate information.

In some embodiments, the gaming machine may include a player or other sensor, such as a camera in communication with the processor (and possibly controlled by the processor) that is selectively positioned to acquire an image of a player actively using the gaming device and/or the surrounding area of the gaming device. In some embodiments, the camera may be configured to selectively acquire still or moving (e.g., video) images and may be configured to acquire the images in either an analog, digital or other suitable format. The display devices may be configured to display the image acquired by the camera as well as display the visible manifestation of the game in split screen or picture-in-picture fashion. For example, the camera may acquire an image of the player and that image can be incorporated into the primary and/or secondary game as a game image, symbol or indicia.

Suitable gaming devices may incorporate any suitable wagering primary or base game. The gaming machine or device of embodiments of the present invention may include some or all of the features of conventional gaming machines or devices. The primary or base game may comprise any suitable reel-type game, card game, number game or other game of chance susceptible to representation in an electronic or electromechanical form which produces a random outcome based on probability data upon activation from a wager. That is, different primary wagering games, such as video poker games, video blackjack games, video Keno, video bingo or any other suitable primary or base game may be implemented into an embodiment of the present invention.

In some embodiments, a base or primary game may be a slot game with one or more pay lines 52. The pay lines may be horizontal, vertical, circular, diagonal, angled or any combination thereof. In this embodiment, the gaming device displays at least one and preferably a plurality of reels 54, for example, having three to five reels 54 in either electromechanical form with mechanical rotating reels or video form with simulated reels and movement thereof. In some embodiments, an electromechanical slot machine includes a plurality of adjacent, rotatable wheels which may be combined and operably coupled with an electronic display of any suitable type. In some embodiments, if the reels 54 are in video form, the plurality of simulated video reels 54 are displayed on one or more of the display devices as described above. Each reel 54 displays a plurality of indicia such as bells, hearts, fruits, numbers, letters, bars or other images which may generally correspond to a theme associated with the gaming device. In this embodiment, the gaming device awards prizes when the reels of the primary game stop spinning if specified types and/or configurations of indicia or symbols occur on an active pay line or otherwise occur in a winning pattern.

In some embodiments, in addition to winning credits in a base or primary game, the gaming device may also give players the opportunity to win credits in a bonus or secondary game or bonus or secondary round. The bonus or secondary game enables the player to obtain a prize or payout in addition to the prize or payout, if any, obtained from the base or primary game. In general, a bonus or secondary game produces a significantly higher level of player excitement than the base or primary game because it provides a greater expectation of winning than the base or primary game and is accompanied with more attractive or unusual features than the base or primary game.

In some embodiments, the bonus or secondary game may be any type of suitable game, either similar to or completely different from the base or primary game. In some embodiments, the gaming device includes a program which will automatically begin a bonus round when the player has achieved a triggering event or qualifying condition in the base or primary game. In some embodiments, the triggering event or qualifying condition may be a selected outcome in the primary game or a particular arrangement of one or more indicia on a display device in the primary game, such as the number seven appearing on three adjacent reels along a pay line in the primary slot game embodiment seen in FIGS. 1A and 1B. In some embodiments, the triggering event or qualifying condition may be by exceeding a certain amount of game play (number of games, number of credits, amount of time), reaching a specified number of points earned during game play or as a random award.

In some embodiments, once a player has qualified for a bonus game, a player may subsequently enhance his/her bonus game participation through continued play on the base or primary game. Thus, for each bonus qualifying event, such as a bonus symbol, that the player obtains, a given number of bonus game wagering points or credits may be accumulated in a “bonus meter” programmed to accrue the bonus wagering credits or entries toward eventual participation in a bonus game. The occurrence of multiple such bonus qualifying events in the primary game may result in an arithmetic or geometric increase in the number of bonus wagering credits awarded. In some embodiments, extra bonus wagering credits may be redeemed during the bonus game to extend play of the bonus game.

In some embodiments, no separate entry fee or buy in for a bonus game need be employed. That is, a player may not purchase an entry into a bonus game; he must win or earn entry through play of the primary game and, thus, play of the primary game is encouraged. In some embodiments, qualification of the bonus or secondary game could be accomplished through a simple “buy in” by the player if, for example, the player has been unsuccessful at qualifying through other specified activities.

In some embodiments, as illustrated in FIG. 2B, one or more of the gaming devices 10 of embodiments of the present invention may be connected to each other through a data network or a remote communication link 58 with some or all of the functions of each gaming device provided at a central location such as a central server or central controller 56. More specifically, the processor of each gaming device may be designed to facilitate transmission of signals between the individual gaming device and the central server or controller.

In some embodiments, the game outcome provided to the player may be determined by a central server or controller and provided to the player at the gaming device of an embodiment of the present invention. In this embodiment, each of a plurality of such gaming devices is in communication with the central server or controller. Upon a player initiating game play at one of the gaming devices, the initiated gaming device communicates a game outcome request to the central server or controller.

In some embodiments, the central server or controller receives the game outcome request and randomly generates a game outcome for the primary game based on probability data. In some embodiments, the central server or controller randomly generates a game outcome for the secondary game based on probability data. In some embodiments, the central server or controller randomly generates a game outcome for both the primary game and the secondary game based on probability data. In this embodiment, the central server or controller is capable of storing and utilizing program code or other data similar to the processor and memory device of the gaming device.

In some embodiments, the central server or controller maintains one or more predetermined pools or sets of predetermined game outcomes. In this embodiment, the central server or controller receives the game outcome request and independently selects a predetermined game outcome from a set or pool of game outcomes. The central server or controller flags or marks the selected game outcome as used. Once a game outcome is flagged as used, it is prevented from further selection from the set or pool and cannot be selected by the central controller or server upon another wager. The provided game outcome can include a primary game outcome, a secondary game outcome, primary and secondary game outcomes, or a series of game outcomes such as free games.

The central server or controller communicates the generated or selected game outcome to the initiated gaming device. The gaming device receives the generated or selected game outcome and provides the game outcome to the player. In an alternative embodiment, how the generated or selected game outcome is to be presented or displayed to the player, such as a reel symbol combination of a slot machine or a hand of cards dealt in a card game, is also determined by the central server or controller and communicated to the initiated gaming device to be presented or displayed to the player. Central production or control can assist a gaming establishment or other entity in maintaining appropriate records, controlling gaming, reducing and preventing cheating or electronic or other errors, reducing or eliminating win-loss volatility and the like.

In some embodiments, one or more of the gaming devices are in communication with a central server or controller for monitoring purposes only. That is, each individual gaming device randomly generates the game outcomes to be provided to the player and the central server or controller monitors the activities and events occurring on the plurality of gaming devices. In some embodiments, the gaming network includes a real-time or on-line accounting and gaming information system operably coupled to the central server or controller. The accounting and gaming information system of this embodiment includes a player database for storing player profiles, a player tracking module for tracking players and a credit system for providing automated casino transactions.

A plurality of the gaming devices are capable of being connected together through a data network. In some embodiments, the data network is a local area network (LAN), in which one or more of the gaming devices are substantially proximate to each other and an on-site central server or controller as in, for example, a gaming establishment or a portion of a gaming establishment. In some embodiments, the data network is a wide area network (WAN) in which one or more of the gaming devices are in communication with at least one off-site central server or controller. In this embodiment, the plurality of gaming devices may be located in a different part of the gaming establishment or within a different gaming establishment than the off-site central server or controller. Thus, the WAN may include an off-site central server or controller and an off-site gaming device located within gaming establishments in the same geographic area, such as a city or state. The WAN gaming system may be substantially identical to the LAN gaming system described above, although the number of gaming devices in each system may vary relative to each other.

In some embodiments, the data network is a global computer network, such as the Internet, or an intranet network, and the gaming system may be considered an online system, a mobile system, or the like. In this embodiment, the operation of the gaming device can be viewed at the gaming device with at least one web browser, or application, such that access to the data network is feasible. In this embodiment, operation of the gaming device and accumulation of credits may be accomplished with a connection to the central server or controller through a conventional phone or other data transmission line, digital signal line (DSL), T-1 line, coaxial cable, fiber optic cable, or other suitable connection. In this embodiment, players may access a game page from any location where a network connection and computer, or other gaming device 10, are available. For example, either of the gaming devices of FIGS. 1C and 1D are suitable for accessing such a data network.

The expansion in the number of computers and number and speed of internet connections in recent years increases opportunities for players to play from an ever-increasing number of remote sites. It should be appreciated that enhanced bandwidth of digital wireless communications may render such technology suitable for some or all communications according to some embodiments of the present invention, particularly if such communications are encrypted. Higher data transmission speeds may be useful for enhancing the sophistication and response of the display and interaction with the player.

In some embodiments, a plurality of gaming devices at one or more gaming sites may be networked to a central server in a progressive configuration, wherein a portion of each wager to initiate a base or primary game may be allocated to bonus or secondary event awards. In some embodiments, a host site computer is coupled to a plurality of the central servers at a variety of mutually remote gaming sites for providing a multi-site linked progressive automated gaming system. In some embodiments, a host site computer may serve gaming devices distributed throughout a number of properties at different geographical locations including, for example, different locations within a city or different cities within a state.

In some embodiments, the host site computer is maintained for the overall operation and control of the system. In this embodiment, a host site computer oversees the entire progressive gaming system and is the master for computing all progressive jackpots. All participating gaming sites report to, and receive information from, the host site computer. Each central server computer is responsible for all data communication between the gaming device hardware and software and the host site computer.

In some embodiments, the data network may be integrated into an existing network platform, for example, a social networking site. For example, in some embodiments, the data network may comprise an application within a social networking site, e.g., Facebook, whereby players may access the data network via a connection to the social networking site. Such an integrated arrangement may be advantageous for applications of embodiments of the present invention that seek to have near immediate access to a significant potential customer base.

In further embodiments, the data network may be accessed via a downloadable application to a mobile device, such as a smartphone, a tablet, a mobile computer, or the like. As is known in the mobile device industry, such a downloadable application may be stored at a remote server, and upon request, a player may utilize a mobile device to download such downloadable application to be stored locally on the mobile device. Such downloadable application may access the data network through the mobile device's network connection, and provide the player a convenient means through which to access the data network. In alternative embodiments, the downloadable application may not require a network connection on a regular basis, and a game may be accessible locally on the mobile device. However, in such embodiments, some of the benefits of networked game play, such as competitions, updates, etc., may not be available until the mobile device reconnects to the data network.

To operate and play the game, a player initially inserts currency through an input device and obtains a number of credits as indicated by the credit display 114. The player begins playing the slot machine by entering a wager through the input device and by depressing the select paylines button to increase the number of paylines wagered. In the examples in the included Figures there are three paylines, 52a, 52b, and 52c, but the invention is envisions with as few as one payline and with more than three paylines. The three paylines are illustrated for simplicity.

Next, the player may press the bet per payline button to increase their bet or wager on each payline from one to three credits as indicated by the bet per payline display 108. Therefore, the player may wager three credits on each of the paylines 52a, 52b and 52c. Based on the wager made by the player in this spin or activation of the reels in the game, a total bet or wager is indicated by the total bet display 110. The total bet equals the number of paylines wagered on by the player of three multiplied by the amount bet per payline by the player. Because the game has not started yet the pay display may indicate a zero or that the player has not received any awards or credits in the game. The total bet made by the player in an activation or spin of the reels is subtracted from the player's total credits in the game which results in the new total number of credits being indicated by the credit display 114.

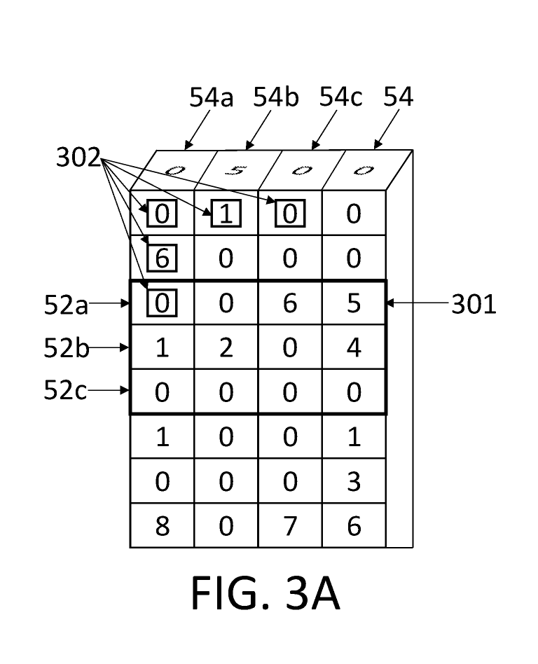

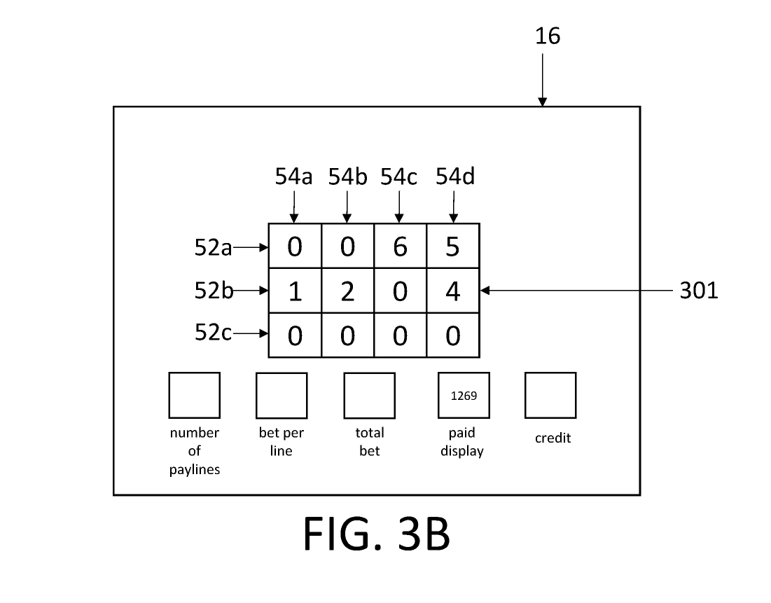

Referring now to FIG. 3A, an exemplary view of reels in accordance with embodiments of the present invention is shown. As shown, a portion of a plurality of reels 54a, 54b, 54c, and 54d are provided. Each of the reels includes a plurality of symbol positions. In some embodiments, there are numeric symbols in the symbol positions as shown by examples 302. A game may include a processor (not shown), that determines a stop position for each reel to indicate which portion of each of the reels is displayed. This portion of each of the reels is displayed in a symbol matrix display such as shown as 301. In this embodiment, the symbol matrix display 301 is a portion of what is displayed on the visual display device. FIG. 3B shows a display of the visual display of this embodiment. As shown, the visual display device displays the portion of the reels, such as 54a, 54b, 54c, and 54d in the symbol matrix, such as 301. The visual display device has other elements, such as a paid display. The paid display, in certain embodiments, displays an award based on a numeric image created from the appearance of adjacent numeric symbols on each payline, such as 52a, 52b, and 52c. FIG. 3B illustrates an example where there are four reels and three paylines.

In some embodiments, display symbols are generated from a template set of base symbols and populated according to a selected schema as disclosed in U.S. Pat. No. 9,022,852 and United States Patent Publication 2015-0235511 which are hereby incorporated by reference in their entireties.

In some embodiments, the gaming device includes a set of meters or displays used to display the relative information for the game, including the number of credits, number of pay lines, amount bet per line, total bet, and the amount paid to the player in a spin of the reels. If necessary, any number of meters may be added to further facilitate control of the games.

In some embodiments, the number of credits in the credit pool is displayed by a credit meter or credit display 114. The pool of credits increases and decreases according to the player's wins or losses in a game and may be supplemented, if necessary, by the player when the player deposits additional coins, tokens or paper currency into the gaming device.

In yet another embodiment, the number of pay lines upon which the player wagered in a game is displayed on a Number of Pay Lines meter or display 106. The pay lines are activated in a predetermined order, as follows: the first wager is applied to pay line 52a; the second wager is applied to pay line 52b; and the third wager is applied to pay line 52c. However, the games may have fewer or greater than three pay lines and activate the paylines in any suitable order.

In a further embodiment, the number of credits wagered on each pay line is displayed on a Bet Per Line display 109. In this embodiment, the same amount is wagered on each of the pay lines. Alternatively, in some embodiments the player could wager different amounts on each pay line in a game.

In some embodiments, the total number of credits bet on all of the pay lines is displayed by a Total Bet display 110. The total bet is calculated by multiplying the number of pay lines by the bet per line. In addition, the number of credits awarded for any winning symbol combinations is displayed by a Paid display 112.

In accordance with exemplary embodiments, a game may comprise a unit reel and one or more numeric reels. As used herein, the terms “unit reel,” “denominations reel,” and “activator reel” may refer to a reel including denominations, or the like, and are used interchangeably herein. To play the game the player may initiate game play after selecting a number of play lines. When game play is initiated a processor may determine the game result or stopping position of each of the reels. The processor may select symbols to be displayed on a display in the symbol matrix in accordance with the stopping position with each of the reels. The unit reel may indicate the type of award, if any, the player will be awarded if numbers are displayed in the same row as a unit symbol in the unit reel. For example, the unit reel may comprise symbol positions including blanks with no value, and unit symbols that indicate a value.

In some embodiments a unit reel may indicate a unit symbol indicating a type of award, such as a dollar sign, a cents sign, a credit symbol, or the like. After the game is played, the player will be awarded any amount shown on the screen that appears in the row same as any unit symbol that is displayed. For example, if a dollar symbol or “$” is displayed, the player will win any numeric amount displayed in the corresponding number columns in the same row as the dollar symbol. If “2” and “0” are displayed in the two right-most reels in the same row as a dollar symbol, the user would be awarded $20, and the like. The unit symbol may indicate the type of award, such as currency, points, prizes, free spins, bonus games, other awards, or the like. If the number reels indicate numbers, but appear in the same row with a blank unit symbol, then the user would not be issued an award for that row. In some embodiments, the unit symbols may be scattered throughout the reels, and the game may be played without a designated unit reel. In some embodiments, an award may be generated if the unit symbol is in a predetermined location with respect to a number in a number column. For example, in some embodiments, if a certain unit appears anywhere in the symbol matrix or row, an award in the amount of any number in the matrix is issued to the player.

In some embodiments, there are numbers displayed in the symbol matrix. In these exemplary embodiments, a player is awarded the number created by adjacent numbers across multiple columns. By way of further explanation, in FIG. 3B, payline 52a has the numbers ‘0,’ ‘0,’ ‘6,’ and ‘5’ on reels 54a, 54b, 54c, and 54d respective creating the visual appearance of the number ‘0065’ or ‘65’ on the payline. Payline 52b has the numbers ‘1,’ ‘2,’ ‘0,’ and ‘4’ on the reels 54a, 54b, 54c, and 54d respective creating the visual appearance of the number ‘1204’ on the payline. Payline 52c has the number ‘0’ on each of the reels creating the visual appearance of the number ‘0000’ or ‘0’ on the payline. As a result, in this example, the award is based on the string of symbols in each payline or 65, 1204, and 0. Consequently, the paid display in FIG. 3B shows 1269 (1204+65). The number of reels, number of paylines, the number of symbol positions on the reels, the numbers in the symbol positions, and the number of displayed symbol positions in the figures are merely examples and other examples are suitable for embodiments of the present disclosure are contemplated.

In some embodiments, each of the symbol positions on the reels includes a randomly determined symbol from the plurality of symbols, based on an algorithmic formula and distribution of symbols. It should be appreciated that any of the symbols may be in any of the symbol positions on the reels.

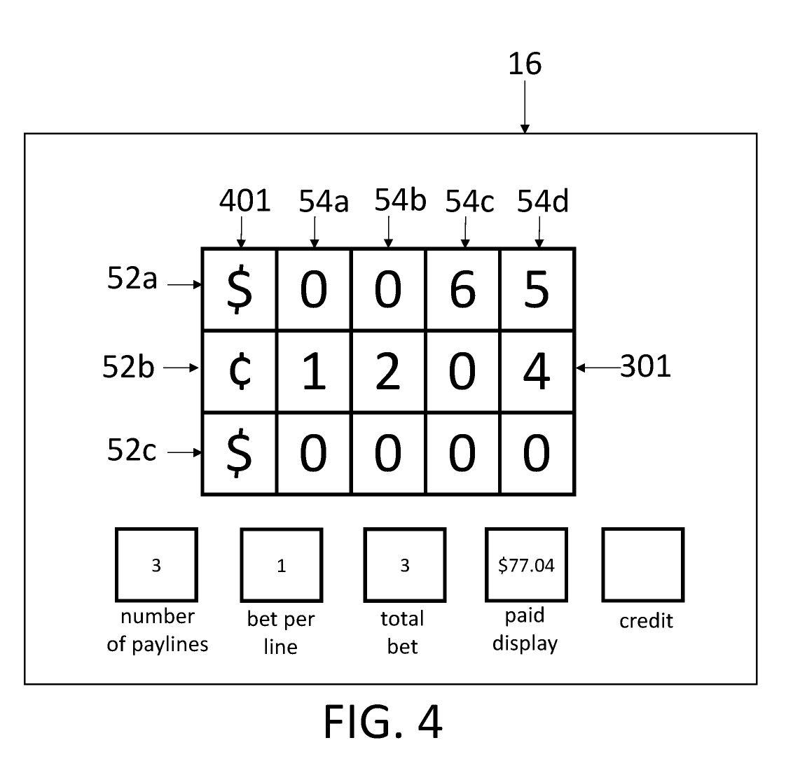

In some embodiments, there is also a denominations reel or activator reel such as the one pictured in FIG. 4. In these embodiments, the denomination reel has symbol positions similar to the symbol positions on the reels 54a, 54b, 54c, and 54d. These positions contain activator symbols with associated denominations. In some of these embodiments, the denomination or activator reel is adjacent to the numeric symbols. Awards are issued if the activator symbol is present and in the associated denomination of the activator symbol and the amount issued by any numbers formed by adjacent numbers across multiple columns. For example, payline 52a has the activator symbol ‘$’ and the appearance of the number ‘0065’ resulting in a 0065 payout in dollars or ‘$65.’ Payline 52b has the activator symbol ‘¢’ and the appearance of the number 1204 resulting in a 1204 payout in cents ‘$12.04.’ Payline 52c has the activator symbol ‘$’ and the appearance of the number 0000 resulting in a zero dollar payout. In this illustrative example, the paid display shows ‘$77.04’ resulting from $65+$12.04+$0.

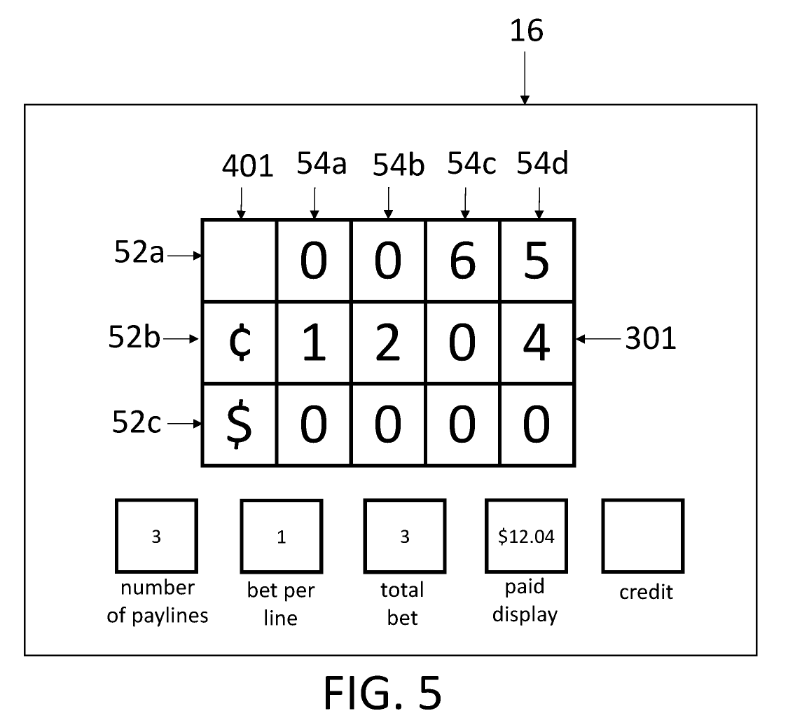

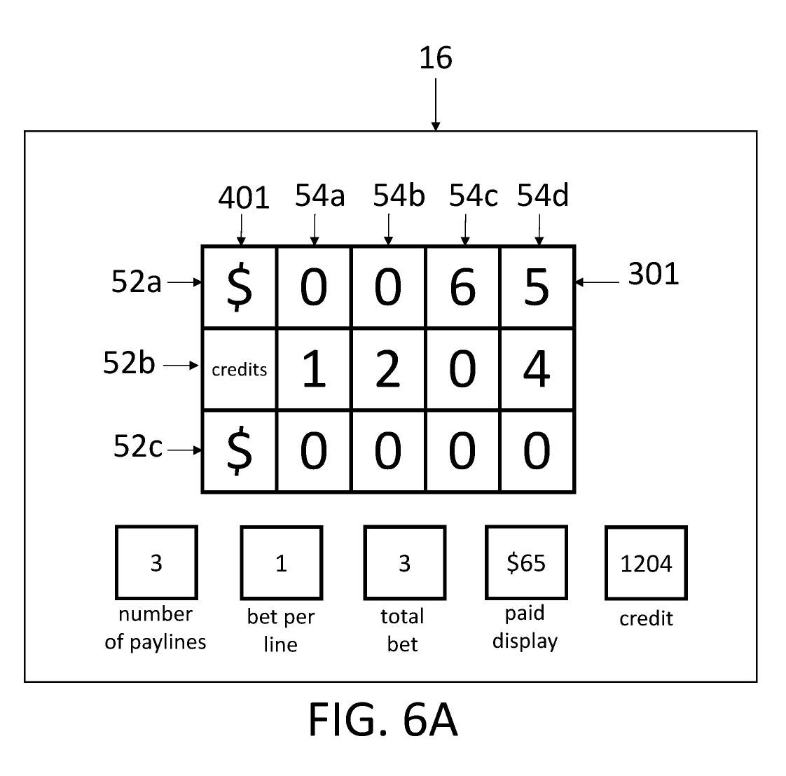

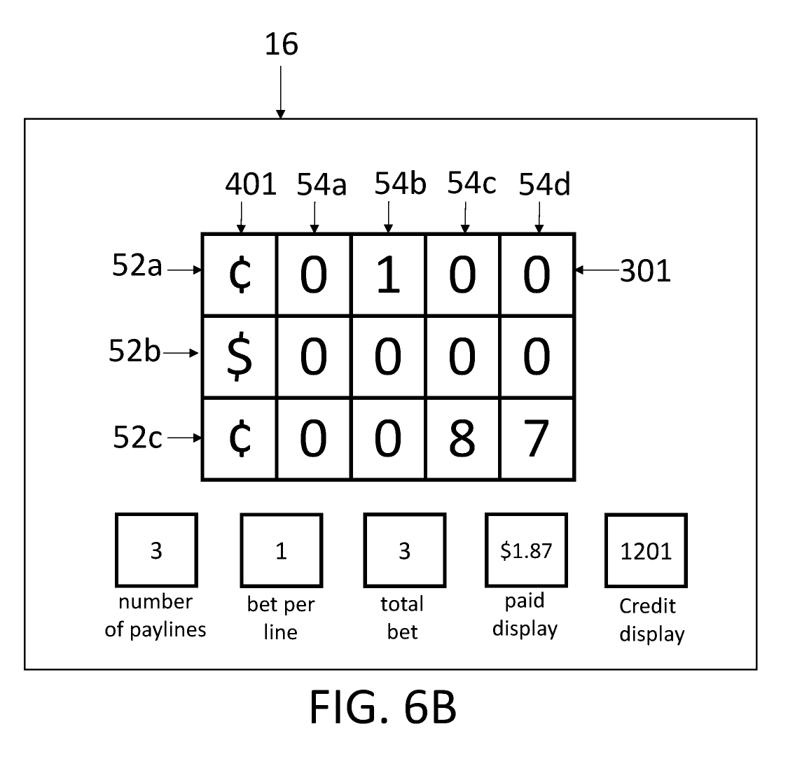

In some embodiments, and as shown in FIG. 5, there are blank symbols on the reels or denomination reels. In some embodiments, and as shown in FIGS. 6A and 6B, some of the denomination or activator symbols have the word ‘credits’ as a symbol. In these embodiments, the activator symbol issues an award of credits in the amount of the numeric string on that payline. By way of example, on FIG. 6A, payline 52b has the denomination/activator symbol ‘credits’ and the adjacent number ‘1204.’ The ‘credit’ display shows ‘1204.’ In FIG. 6B, the ‘credit’ display shows ‘1201’ as the player has wagered 3 credits on a new run of the slot machine.

In some embodiments, a unit reel is not included and alternatively, a color indicator, background color, or the like, is present on each symbol having a numeric amount. In these embodiments, a user may choose to wager on one or more of the colors, or the like. If a numeric amount is present in the game result a color indicator that matches the user's wager appears in the play matrix after a game, the player is awarded the numeric amount present in that symbol position.

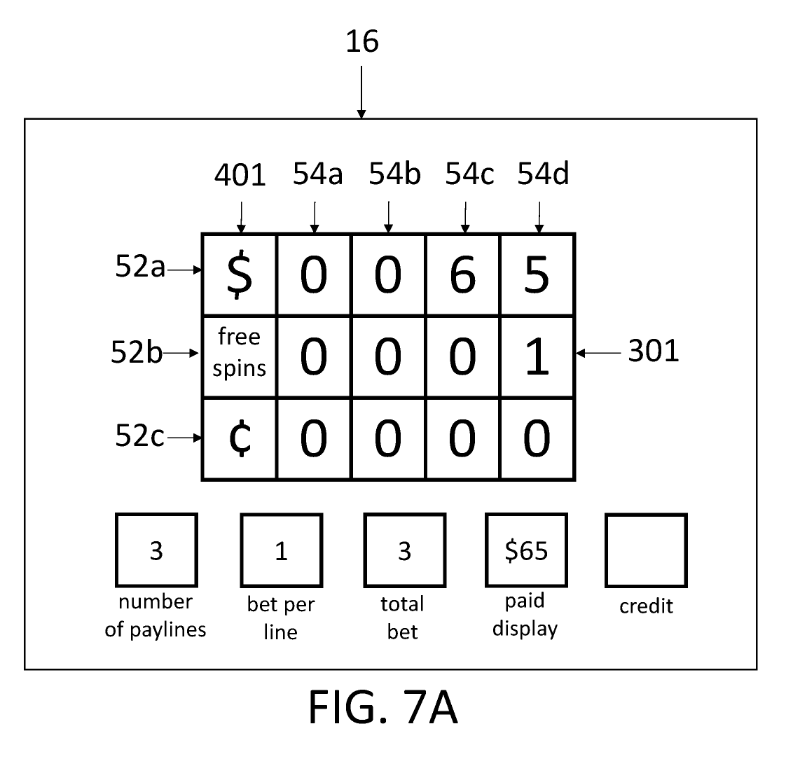

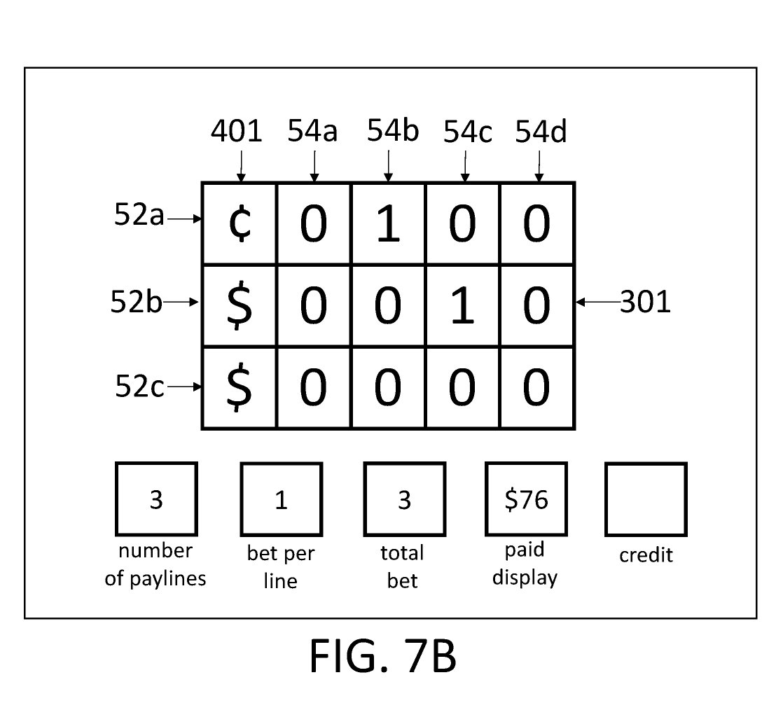

In some embodiments, and as shown in FIGS. 7A and 7B, some of the activator symbols have the word ‘free spins’ as a denomination. In these embodiments, an award includes additional spins in the amount of the adjacent numbers across multiple columns. By way of example, on FIG. 7A payline 52a has the denomination/activator symbol ‘$’ and the numeric string ‘0065.’ The visual display device shows the award ‘$65’ in the paid display across the reels. Payline 52b has the activator symbol with the denomination ‘free spins’ and the numeric string ‘0001’ or ‘1.’ Turning to FIG. 7B, payline 52a has the activator symbol in denomination (cents) and visual appearance of number 100 resulting in a payout of ‘¢0100’ or ‘$1,’ payline 52b has the activator in denomination dollars ($) and number 10 resulting in a payout of ‘$0010’ or ‘$10,’ and payline 52c has the activator symbol in dollar denomination ($) and number 0 resulting in a payout of ‘$0000’ or ‘$0. As a result, in this embodiment, the award is $76 (equal to $10 and $1 added to $65).

In some embodiments of the present disclosure, one or more denomination symbols may be included. Denomination symbols may indicate the type of award that may be issued to the player. For example, a denomination symbol may comprise a dollar sign or a symbol spelling out the word “credit,” or the like. In this example, a dollar sign may indicate that an award will be issued in the denomination of dollars and a “credit” symbol may indicate that an award will be issued in credits. In some embodiments, denomination symbols may be located on a dedicated denomination reel. In some embodiments, denomination symbols may be dispersed throughout the reels.

In some embodiments one or more reels may include a numerical symbol. A numerical symbol may include a number, or any symbol that matches, correlates to, or otherwise indicates a number. For example, a numerical symbol may include the number 15, indicating that the player will win 15 of a denomination that may be indicated by a denomination symbol. In some embodiments, a numerical symbol may correspond with a value but may not be a number itself. For example, a numeric symbol may comprise a depiction of the letter “C” which may be configured to correspond to a value of 100. In this example, when a “C” appears in the play matrix on the same pay line as a denomination symbol, the user would be awarded 100 of a denomination. A numeric symbol may be a number, or may be a set of symbols that correspond to numeric values as configured by an administrator, or the like. In some embodiments, the numerical symbol may comprise more than one digit. In some embodiments, the value of the numerical symbol is determined by the reel number. For example, one reel may be worth 100, a second reel may be worth 10, and a third reel may be worth 1. If the result of the game is a 2 in the reel valued at 100, a 7 in the reel valued at 10, and 4 in the reel valued at 1, the resulting award would be 274 of a denomination indicated by denomination symbol, or the like.

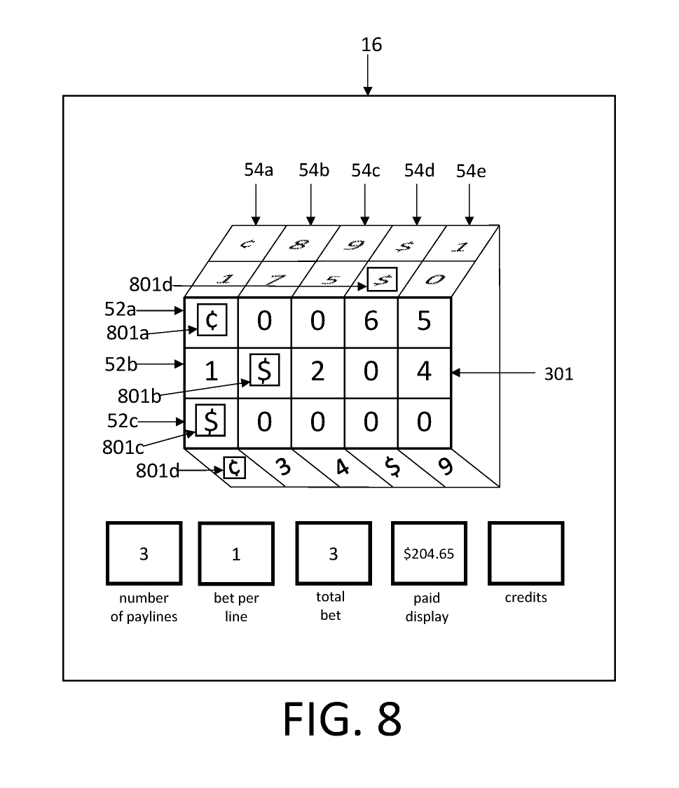

In some embodiments, and as illustrated in FIG. 8, denomination symbols are on the reels, such as reels 54a, 54b, 54c, 54d, and 54e. In these embodiments, there is no separate denomination reel 401. In some of these embodiments, awards are based on any activator symbols and any adjacent numbers formed across columns until either the end of the row or the appearance of a new activator symbol. By way of example, FIG. 8 shows an embodiment with activator symbols 801a-e on the reels. In this example, payline 52a has the cents activator symbol with 0065 adjacent to the activator resulting in a payout of ‘¢0065’ or ‘¢65,’ payline 52b has the dollar activator and a number 204 adjacent resulting in a payout of ‘$204’ and payline 52c has a dollar activator with adjacent number 0000 resulting in ‘$0.’ Symbols without an activator are not associated with a payout. For example, the ‘1’ symbol on reel 54a, payline 52b.

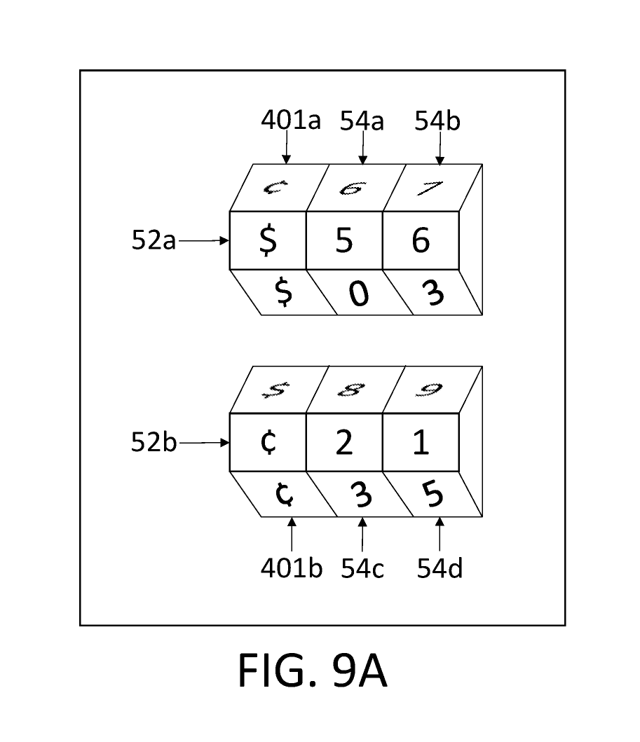

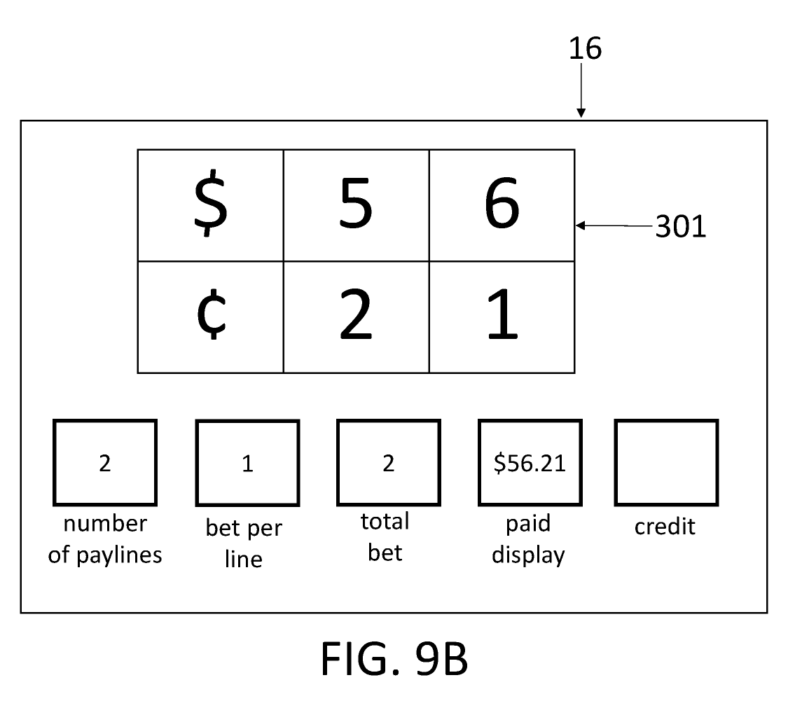

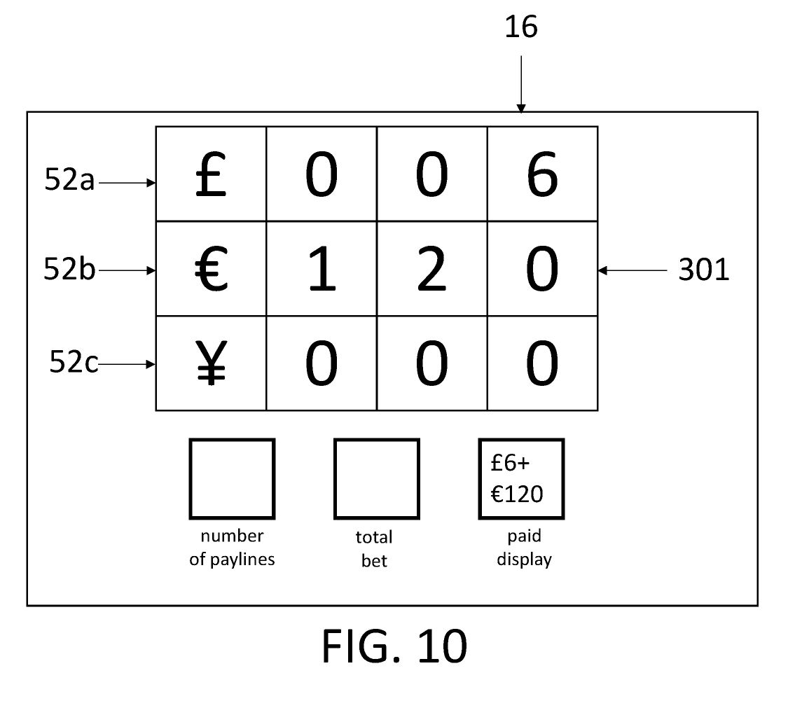

In exemplary embodiments, and as illustrated in FIGS. 9A-B, only one symbol position from each reel is displayed. In these embodiments, known as “independent reels.” In some embodiments, and as shown in FIG. 10, the activator symbols include foreign currency denominations. In these embodiments, the award may be issued in the foreign denomination.

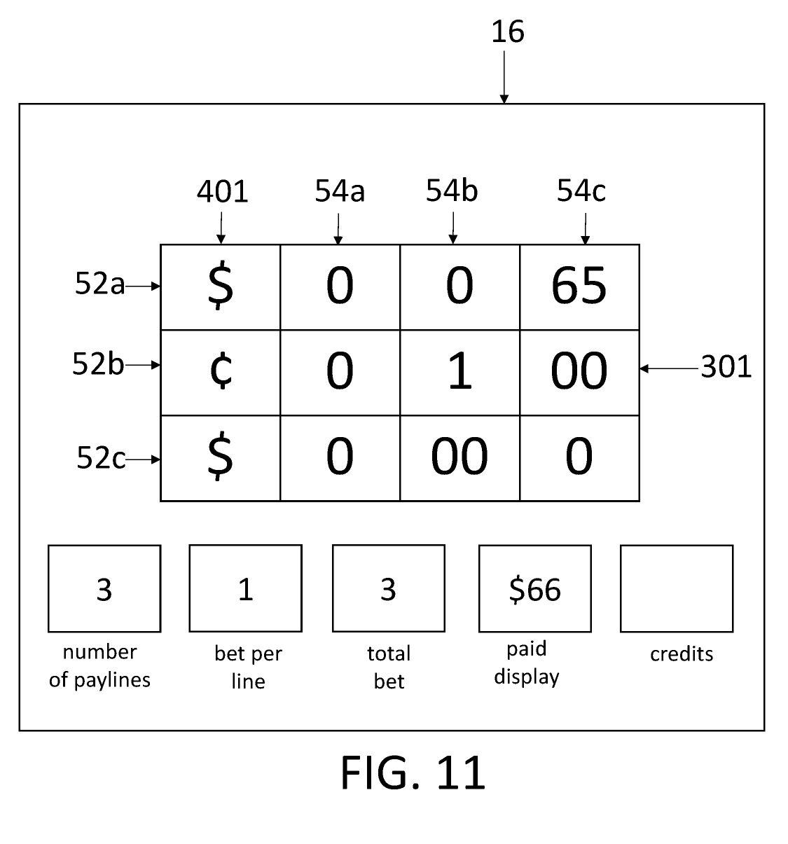

In some embodiments, and as shown in FIG. 11, the numbers may be multiple digits. In these embodiments, the award is still based on the visual appearance of a number on the paylines and across multiple reels. By way of example, FIG. 11 shows a visual display with numbers that have multiple digits. The number ‘65’ is on reel 54c on payline 52a and visually reads “$0065” or $65. The number ‘00’ is on reel 54c on payline 52b and causes the number to read “¢0100’ or $1. The number on reel 54b on payline 52c is ‘00’ causing the number to read “$0000” or $0. The resulting award, in this example, is $66.

In some embodiments, symbols involved in an award are removed, new symbols appear, and the symbol matrix is reevaluated for awards based on the appearance of new denomination/numeric strings. The removed symbols may be populated based on the next symbol in the reel tumbling, randomly generated, or be based on a corresponding, invisible reel. Other variations are disclosed in U.S. Pat. Nos. 7,357,713; 7,887,407; and 9,129,479 which are incorporated by reference herein.

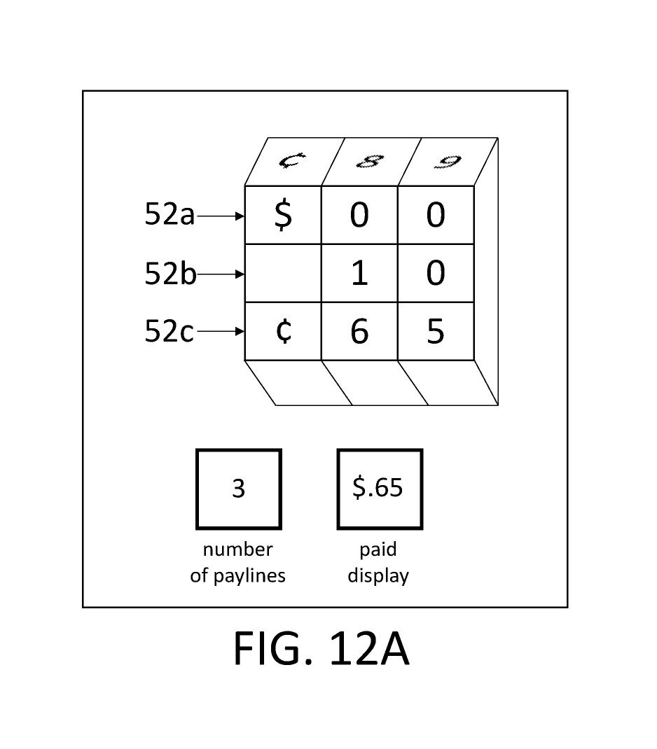

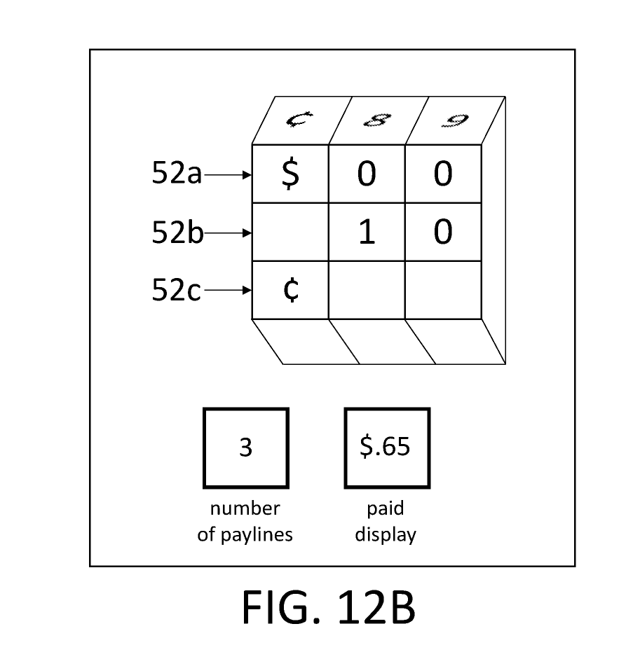

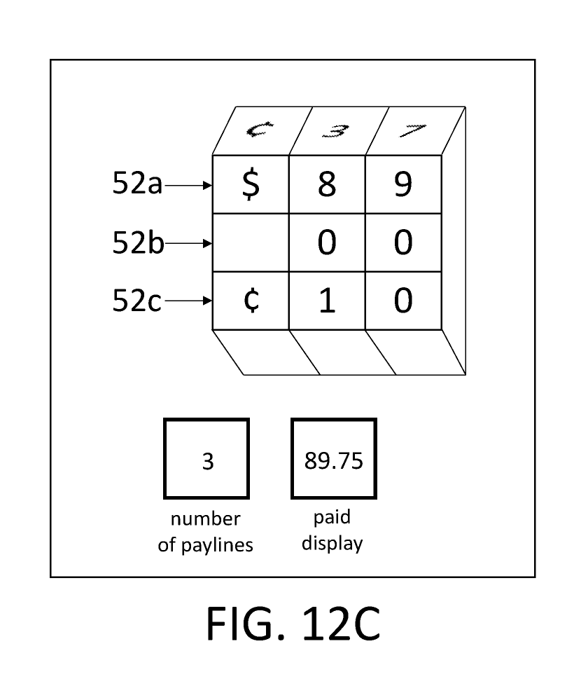

In some embodiments, only the numeric symbols involved in a winning combination are removed and the denomination symbols remain. An example of this embodiment is illustrated in FIGS. 12A-C. In FIG. 12A, payline 52c has an award of ‘¢65.’ The numeric symbols ‘6’ and ‘5’ are removed in FIG. 12B. In FIG. 12C, the numeric symbol ‘1’ is moved down to payline 52c, the numeric symbol ‘0’ is moved down to payline 52b, and the numeric symbol ‘8’ is moved from the next position on the reel to be on payline 52a. Similarly, the numeric symbol ‘0’ is moved to payline 52c, the numeric symbol ‘0’ is moved to payline 52b, and the numeric symbol ‘9’ is moved to payline 52a. After the replacements, payline 52c now has the denomination/numeric string of ‘¢10’ or $0.10 and payline 52a has the denomination/numeric string of $89. Therefore, in this example $89.10 is added to the previous award of $0.65 and the total award is $89.75.

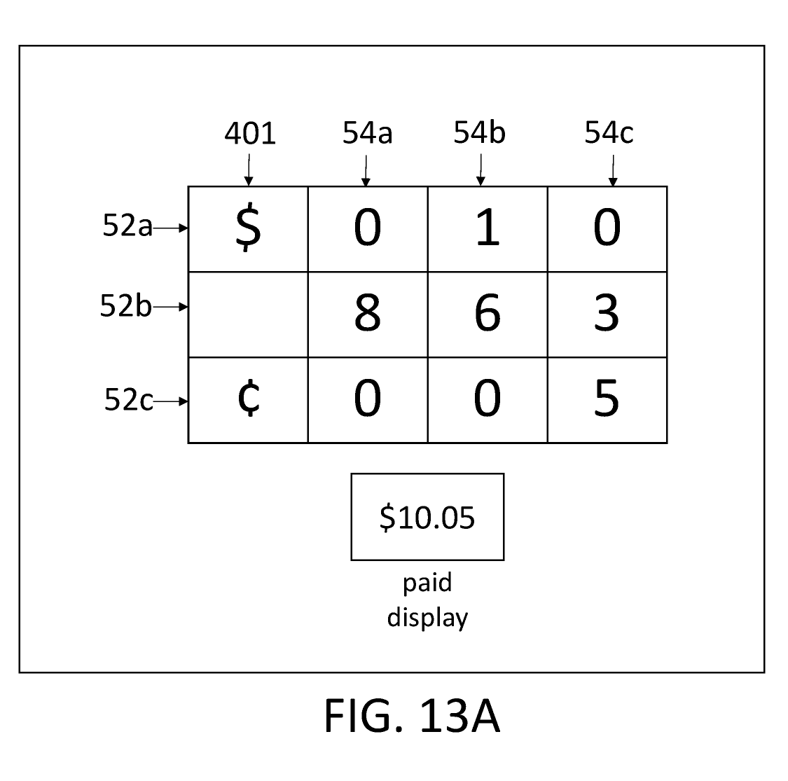

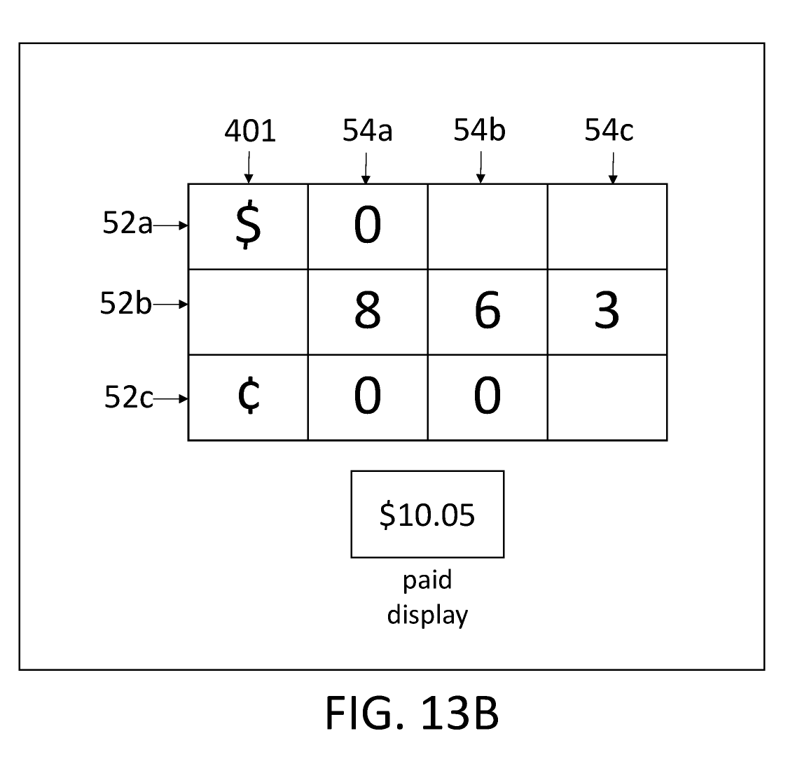

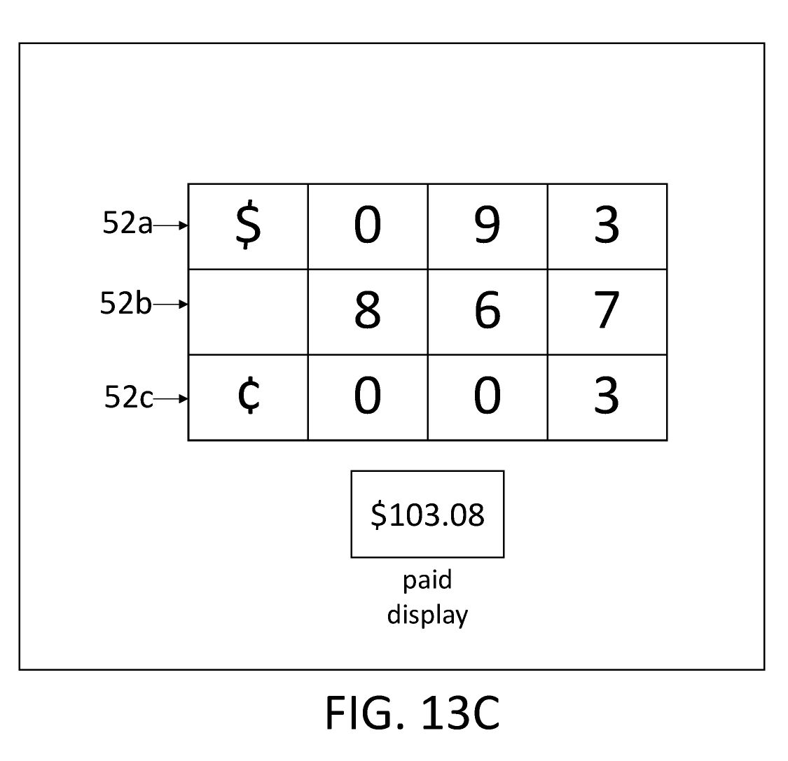

In some embodiments, leading zeros are not removed as they do not “contribute” to the awards. For example, in FIG. 13A, payline 52c shows ‘¢005’ or ‘¢5/$0.05’ and payline 52a shows ‘$010’ or ‘$10.’ The numeric symbol ‘5’ on payline 52c is removed, the ‘1’ on payline 52a is removed and the ‘0’ on reel 54c/payline 52a is removed in FIG. 13B. The ‘0’ numeric symbols on reel 54a/payline 52a, reel 52a/payline 52c, and reel 54b/payline 52c are not removed as they do not contribute to the award. In FIG. 13C, the other symbols on the reels have moved down to fill in gaps left by the removed symbols.

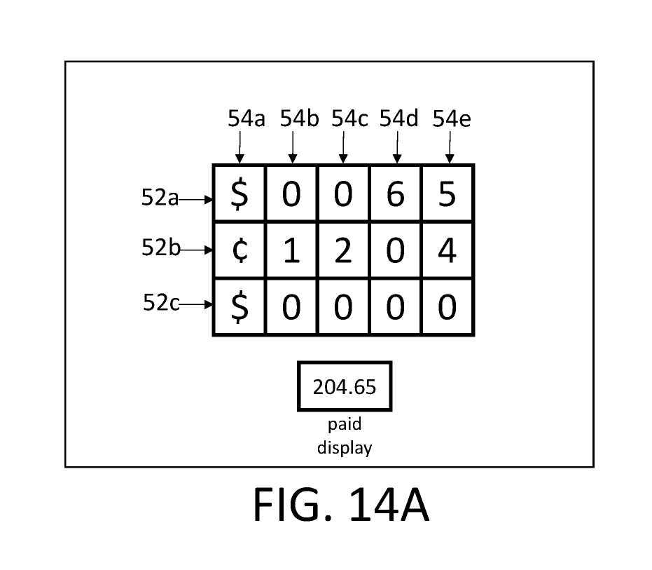

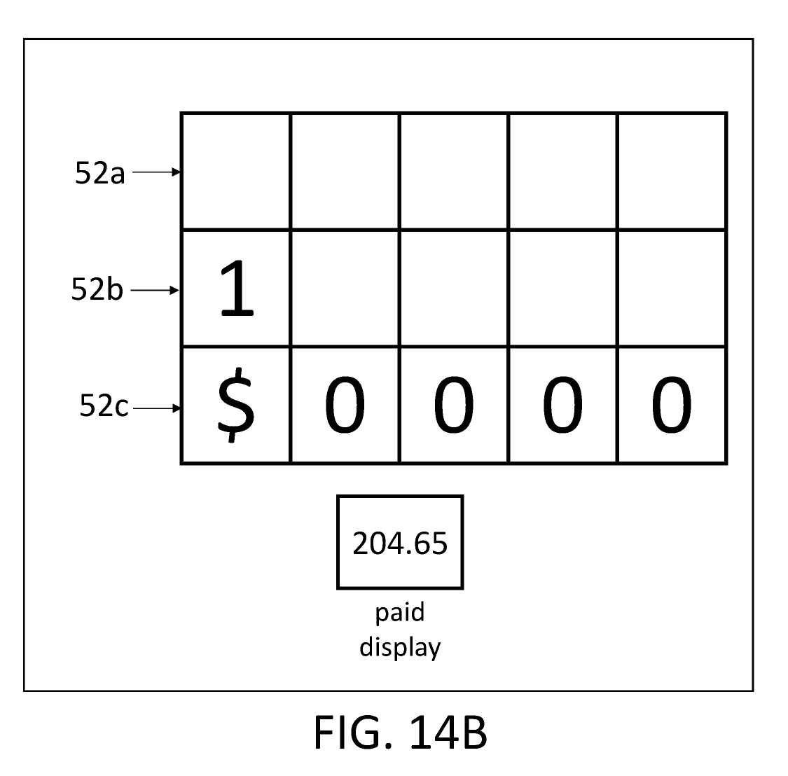

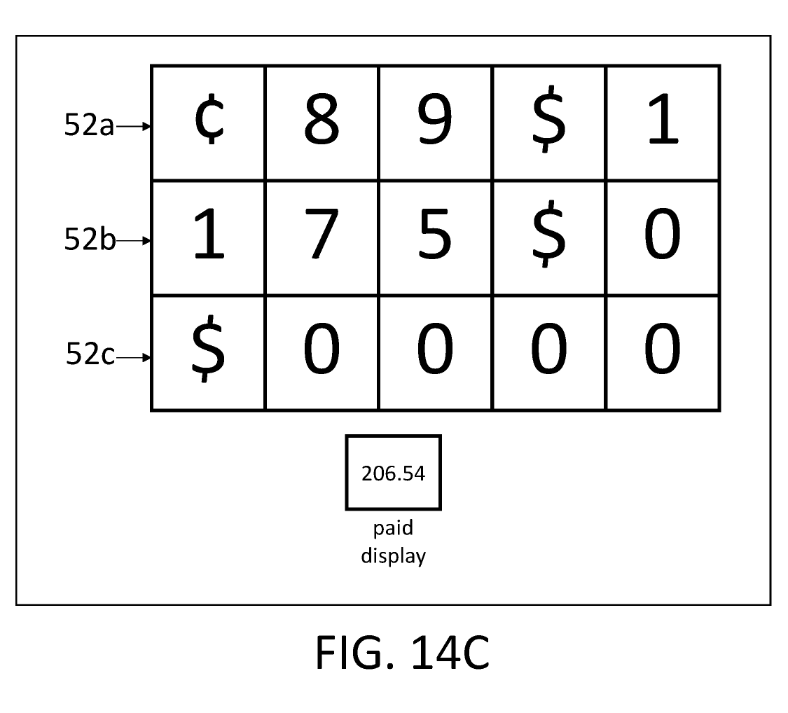

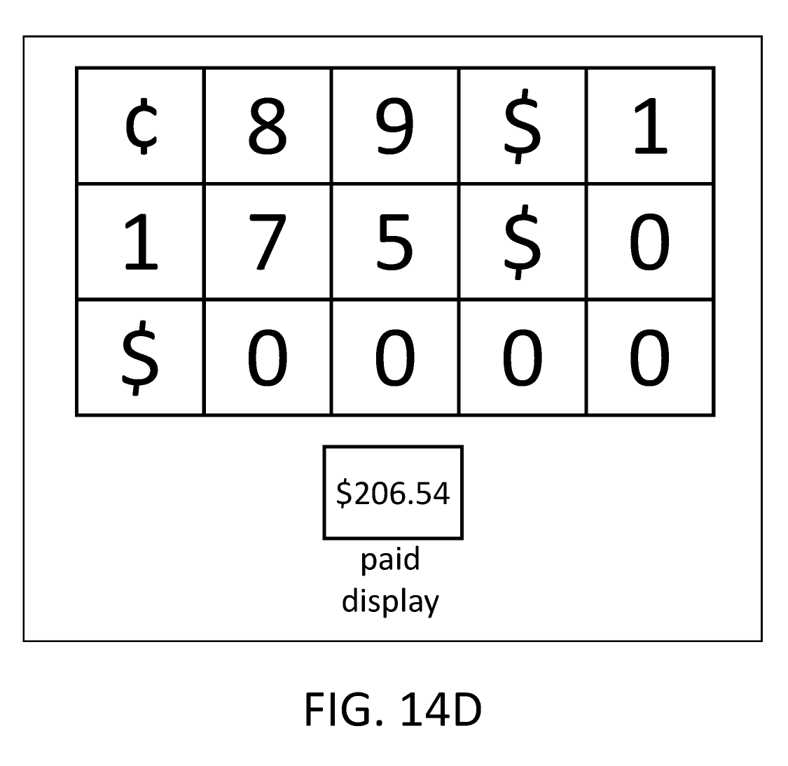

In some embodiments, the entire denomination/numeric string associated with an award is removed. In these embodiments, the denomination symbol is removed in addition to the numeric symbols. In some embodiments, a $0 award is not considered a “winning” award. An example of one of these embodiments is presented in FIGS. 14A-D. In FIG. 14A, payline 52a has the denomination/numeric string combination of ‘¢0065,’ payline 52b has a non-denominational ‘1’ numeric symbol on reel 54a and the denomination/numeric string ‘$204,’ and payline 52c has the denomination/numeric string ‘$0000.’ The award is based on ‘¢0065’ on payline 52a and ‘$204’ on payline 52b. The numeric symbol 1 that does not have a denomination is not included in a part of the award. FIG. 14B shows all the symbols from payline 52a removed and the symbols, ‘$,’ ‘2,’ ‘0,’ and ‘4’ removed. FIG. 14C shows the result after new symbols take the place of the removed symbols. As shown in FIG. 14C, the resulting symbols may include new winning awards such as ‘¢89’ and ‘$1’ as shown in payline 52a. In exemplary embodiments, the symbols associated with the new awards are also removed. FIG. 14D shows replacement of the symbols in payline 52a.

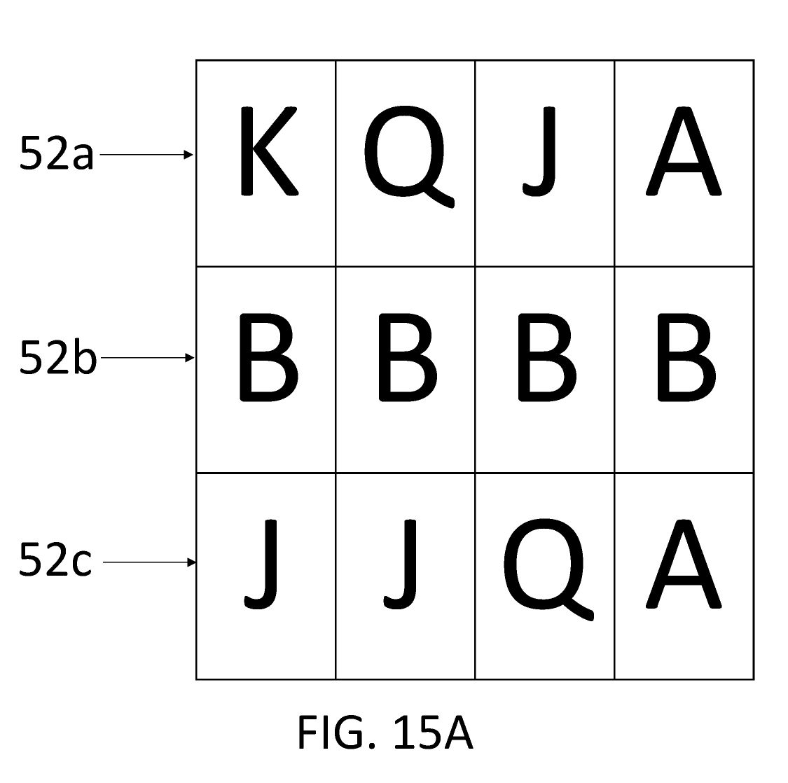

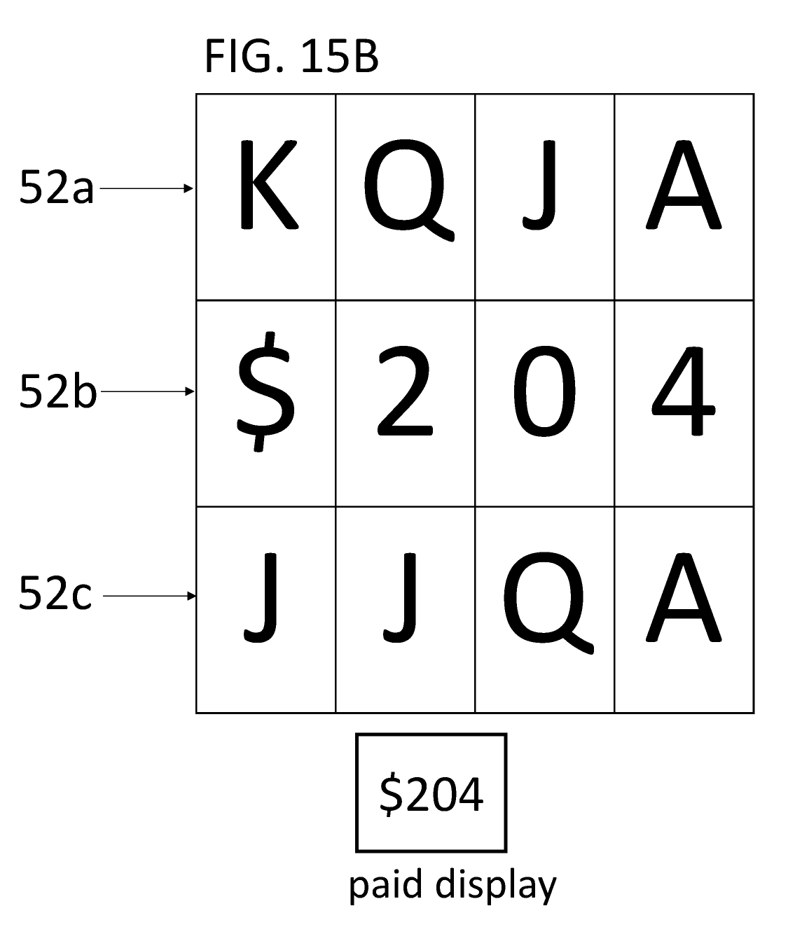

In some exemplary embodiments, this feature occurs within a traditional slot game. In these embodiments, a triggering condition causes a number of symbols on multiple reels to reveal numbers. For example if multiple symbols on a row are “B” symbols, in certain embodiments, those symbols will be reveal numbers and an activator with a denomination. In FIGS. 15A and 15B, all symbols on payline 52b are “B” symbols, and so trigger a reveal of an activator with a denomination and a corresponding multi-digit number that spans multiple reels. In 15B, the B symbols reveal activator in denomination $ with the numbers “2,” “0,” and “4” or $204. The player is then issued the corresponding award. It should be appreciated that not all symbols on a row need to be numbers for a n award to be issued.

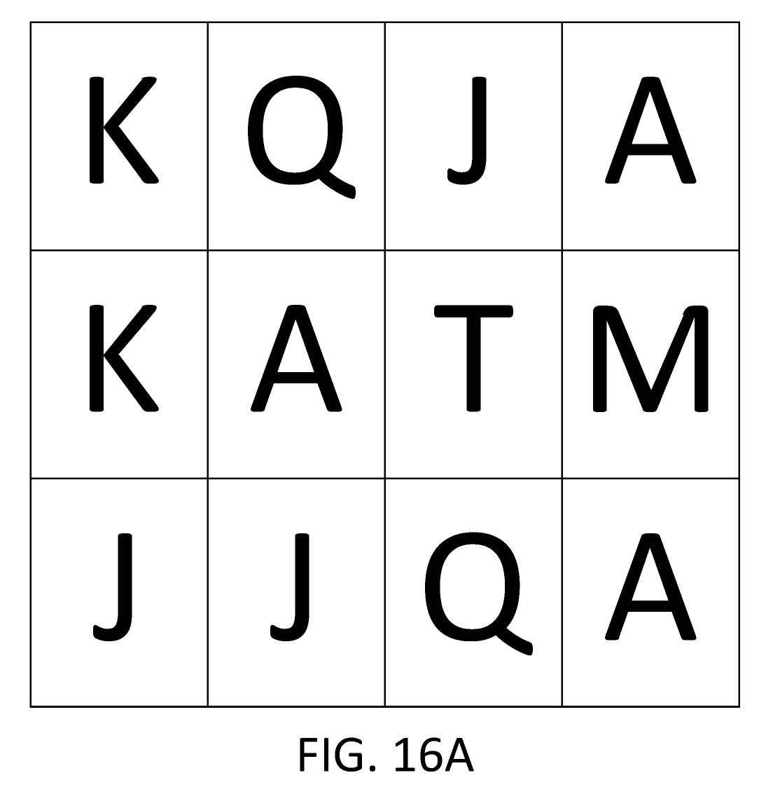

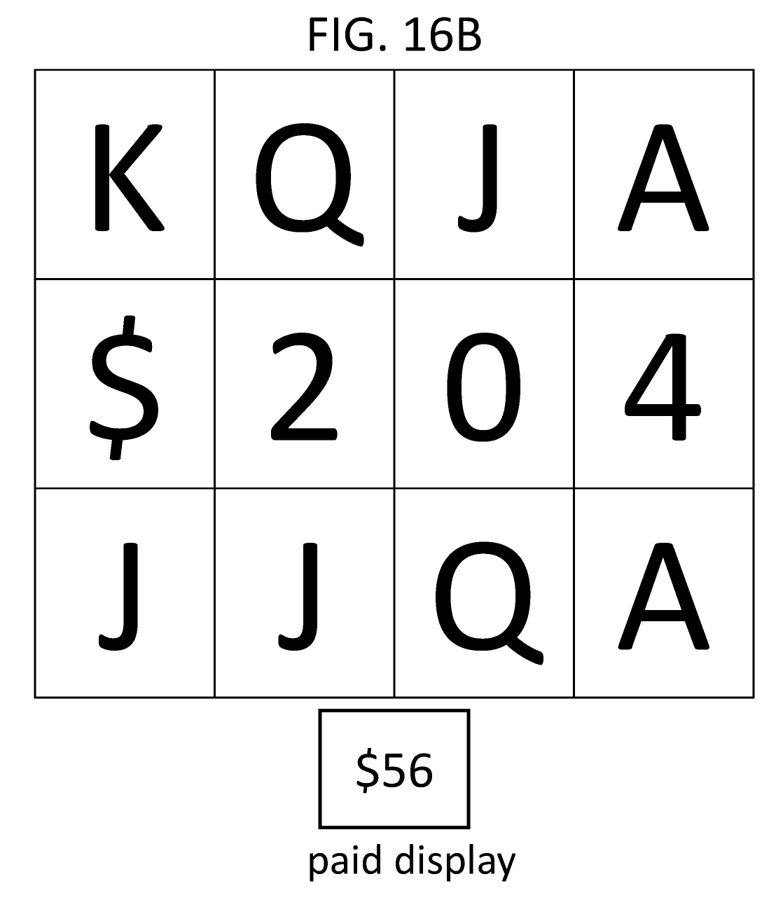

In some embodiments, the triggering condition is a plurality of adjacent trigger symbols. In some embodiments, the triggering condition is spelling out a word across the reels. In an exemplary embodiment, the letters “A,” “T,” and “M” in adjacent symbols spelling out “ATM” trigger a reveal of numbers and an award equal to the cross-column display. FIG. 16A shows a reveal of a ATM in a primary game and the corresponding revealed symbols $5 and 6 in its place in FIG. 16B along with the $56 payout.

It should be emphasized that the above-described embodiments of the present invention are merely possible examples of implementations, merely set forth for a clear understanding of the principles of the invention. Many variations and modifications may be made to the above-described embodiment(s) of the invention without departing substantially from the spirit and principles of the invention. For example, an element disclosed by one embodiment of the present invention may be included in any other disclosed embodiment, where suitable. All such modifications and variations are intended to be included herein within the scope of this disclosure and the present invention.

What is claimed is:

1. A game comprising:
a plurality of reels, each of the reels comprising a plurality of symbol positions;
at least one reel of the plurality of reels comprising a number of denomination symbols;
at least one reel of the plurality of reels comprising a number of numerical symbols;
a set of program instructions executable to implement:
accepting a wager associated with a number of pay lines;
determining a game outcome including a stopping point of the plurality of reels;
displaying a portion of the plurality of reels at the stopping point on a display device; and
issuing an award indicated by numerical symbols on the same pay line as a denomination symbol.

2. The game of claim 1 wherein the award is issued in a denomination indicated by the denomination symbol.

3. The game of claim 1, wherein each of the plurality of reels comprises at least one blank symbol.

4. The game of claim 1, wherein the denomination symbol comprises at least one of a currency symbol, a credit symbol, or a free spins symbol.

5. The game of claim 1, wherein only one position from each reel is displayed on the display device.

6. The game of claim 1 wherein the numerical symbol comprises a number.

7. The game of claim 6, wherein the numerical symbol comprises more than one digit.

8. The game of claim 1, wherein the numerical symbol comprises a representation of a number.

9. A game comprising:
a plurality of reels, each of the reels comprising a plurality of symbol positions, at least one of the plurality of symbol positions comprising a blank symbol;
at least one reel of the plurality of reels comprising a number of denomination symbols;
at least one reel of the plurality of reels comprising a number of numerical symbols;
a set of program instructions executable to implement:
accepting a wager associated with a number of pay lines;
determining a game outcome including a stopping point of the plurality of reels;
displaying a portion of the plurality of reels at the stopping point on a display device; and
issuing an award indicated by numerical symbols on the same pay line as a denomination symbol, wherein the award is issued in a denomination indicated by the denomination symbol.

10. The game of claim 9, wherein the denomination symbol comprises at least one of a currency symbol, a credit symbol, or a free spins symbol.

11. The game of claim 9, wherein only one position from each reel is displayed on the display device.

12. The game of claim 9, wherein the numerical symbol comprises a number.

13. The game of claim 12, wherein the numerical symbol comprises more than one digit.

14. The game of claim 9, wherein the numerical symbol comprises a representation of a number.

15. A method of operating a game comprising:
providing a game comprising:
a plurality of reels, each of the reels comprising a plurality of symbol positions;
at least one reel of the plurality of reels comprising a number of denomination symbols;
at least one reel of the plurality of reels comprising a number of numerical symbols;
receiving a wager associated with a number of pay lines;
determining a game outcome including a stopping point of the plurality of reels;
displaying a portion of the plurality of reels at the stopping point on a display device; and
issuing an award indicated by numerical symbols on the same pay line as a denomination symbol.

16. The method of claim 15 wherein the award is issued in a denomination indicated by the denomination symbol.

17. The method of claim 15, wherein each of the plurality of reels comprises at least one blank symbol.

18. The method of claim 15, wherein the denomination symbol comprises at least one of a currency symbol, a credit symbol, or a free spins symbol.

19. The method of claim 15 wherein the numerical symbol comprises a number.

20. The method of claim 15, wherein the numerical symbol comprises a representation of a number.
